(19) United States
(12) Patent Application Publication
(10) Pub. No.: US 2014/0108152 A1
(43) Pub. Date: Apr. 17, 2014

(54) Managing Social Network Relationships Between A Commercial Entity and One or More Users

(71) Applicant: Google Inc., (US)

(72) Inventors: Ping Wu, Saratoga, CA (US); Jennifer W. Lin, San Jose, CA (US)

(73) Assignee: Google Inc., Mountain View, CA (US)

(21) Appl. No.: 13/651,292

(22) Filed: Oct. 12, 2012

(51) Int. Cl. G06Q 30/02; G06Q 99/00

(52) U.S. Cl. 705/14.66; 705/319

(57) ABSTRACT

Systems and methods for managing relationships between a commercial entity and one or more of a plurality of users is described. One of the methods includes receiving data regarding a first opinion of one of the users. The first opinion is concerned with a first product/service. The user has a user identity (ID), the commercial entity has a commercial entity ID, the first product has a first product ID, and the first service has a first service ID. The method further includes mapping the first opinion data with the user ID and the commercial entity ID and the first product ID or the first service ID. The method includes creating data regarding a first sentiment group within a social network account of the commercial entity based on the mapped first opinion data. The method includes assigning the user ID to the first sentiment group data.

### BACKGROUND

With the advancement of computer networks, there is an increase in use of social networks. A variety of people interact with each other by posting, commenting, and sharing images with each other on the social networks. Also, the social networks promote social network friendships and other online relationships between people.

In addition to people becoming members of a social network, an organization can also become a member of the social network. The organization uses the social network to communicate with people. However, relationship between the organization and people can further be improved.

### SUMMARY

Various implementations described in the present disclosure provide systems and methods for managing network relationships between a commercial entity and one or more users. It should be appreciated that the implementations described in the present disclosure may be implemented in numerous ways, e.g., a process, an apparatus, a system, a device or a method on a computer-readable medium. Various implementations of the present disclosure are described below.

In a variety of implementations, a manner of improving relationships between a commercial entity and users is described. For example, as a number of users that follow a commercial entity increases, it becomes difficult for the commercial entity to keep track of opinions of the users regarding the commercial entity. A processor collects opinions of a number of users towards the commercial entity and/or product/services offered by the commercial entity, and classifies the opinions as sentiments of social groups. Each social group includes one or more users that follow the commercial entity. When users are classified into social groups based on sentiments, it becomes easier for the commercial entity to determine users that are happy or unhappy with the commercial entity and/or its products/services, and focuses marketing efforts accordingly.

In various implementations, a method for managing relationships between a commercial entity and one or more users is described. The method includes receiving data regarding a first opinion of one of the users. The first opinion is concerned with a first product or first service offered by the commercial entity. Also, the user is designated as a social network friend of the commercial entity within a social network account of the commercial entity. The social network account is maintained in a first social network. Moreover, the user has a user identity (ID) within the first social network, the commercial entity has a commercial entity ID within the first social network, the first product has a first product ID within the first social network, and the first service has a first service ID within the first social network. The method further includes mapping the first opinion data with the user ID and the commercial entity ID and the first product ID or the first service ID. The method includes creating data regarding a first sentiment group within the social network account of the commercial entity based on the mapped first opinion data. The first sentiment group provides an indication of a first sentiment of the user regarding the first product or first service. The method includes assigning the user ID to the first sentiment group data.

In a number of implementations, the operation of receiving data regarding the first opinion is performed by crawling one or more web pages. The one or more web pages are displayed at one or more client devices.

In several implementations, the operation of crawling one or more web pages includes crawling a web page for structured data communicated between the user and other users, crawling a web page for unstructured data communicated between the user and the other users, or a combination thereof.

In various implementations, the operation of crawling of one or more web pages includes crawling a web page to obtain data regarding a like or a dislike by the user of the first product or first service.

In a number of implementations, the method further includes assigning an opinion ID to the first opinion data. The operation of mapping the first opinion data with the user ID and the commercial entity ID and the first product ID or the first service ID includes associating the user ID and the commercial entity ID and the first product ID or the first service ID with the opinion ID.

In several implementations, the operation of creating the first sentiment group data includes generating data regarding whether the one or more of the users are dissatisfied with the first product or first service or data regarding whether the one or more users are satisfied with the first product or first service.

In various implementations, the operation creating the first sentiment group data includes generating data regarding one of discrete representations of sentiments of the one or more users.

In several implementations, the operation of creating the first sentiment group data includes generating alphanumeric data regarding one of continuous representations of sentiments of the one or more users.

In various implementations, the method further includes dynamically associating the first sentiment group data and the user ID with a second product or second service offered by the commercial entity. The second product is related to the first product and the second service is related to the first service.

In a number of implementations, the method includes determining a probability that the mapped first opinion data applies to a second product or second service. The second product is assigned a second product ID and the second service is assigned a second service ID. The second product is offered by the commercial entity and the second service is offered by the commercial entity. The method includes mapping the first opinion data with the user ID and the commercial entity ID and the second product ID or the second service ID upon determining that the probability exceeds a threshold. The method includes creating second sentiment group data within the social network account of the commercial entity based on the first opinion data that is mapped with the second product or second service.

In several implementations, the operation of assigning the user ID to the first sentiment group data includes creating instruction data to display a representation of the user with respect to a representation of the first sentiment.

In various implementations, the method includes receiving data regarding a second opinion of the user. The second opinion is concerned with the first product or first service. The method further includes assigning a first weight to the first opinion data and assigning a second weight to the second opinion data. The second weight is greater than the first weight and the second opinion data is received after the reception of the first opinion data. The method includes mapping the second opinion data with the user ID and the commercial entity ID and the first product ID or the first service ID. The method includes creating data regarding a second sentiment group within the social network account of the commercial entity based on the mapped second opinion data. The second sentiment group provides an indication of a second sentiment of a social group regarding the first product or first service. The method includes removing the assignment of the user ID from the first sentiment group data and assigning the user ID to the second sentiment group data.

In several implementations, the method includes determining data regarding an offer for selling the first product or first service to the user based on the second sentiment group data.

In a number of implementations, the method includes determining data regarding an offer for selling the first product or first service to the user based on the first sentiment group data.

In various implementations, a method for managing relationships between a commercial entity and one or more users is described. The method includes receiving data regarding an opinion of one of the users. The opinion is concerned with a product or service offered by the commercial entity. The user is designated as a social network friend of the commercial entity within a social network account of the commercial entity. The social network account is maintained in a social network, the user has a user identity (ID) within the social network, the commercial entity has a commercial entity ID within the social network, the product having a product ID within the social network, and the service has a service ID within the social network. The method includes sending the opinion data via a network to a server and receiving data regarding a sentiment group and data regarding a representation of the user from the server. The opinion data is mapped with the user ID and the commercial entity ID and the product ID or the service ID. The sentiment group data is created based on the mapped opinion data and provides an indication of a sentiment of a social group regarding the product or service. The method includes displaying the sentiment group within the social network account of the commercial entity based on the sentiment group data and displaying the representation of the user with respect to the sentiment group based on the data regarding the representation of the user.

In a number of implementations, the method includes receiving data regarding an offer for selling the product or service to the user. The offer data is generated based on the sentiment group data. The method includes displaying the offer to the user.

In several implementations, a system for managing relationships between a commercial entity and one or more users is described. The system includes a network interface controller configured to receive data regarding a first opinion of one of the users. The first opinion is concerning a first product or first service offered by the commercial entity. The user is designated as a social network friend of the commercial entity within a social network account of the commercial entity. The social network account is maintained in a first social network. The user has a user identity (ID) within the first social network, the commercial entity has a commercial entity ID within the first social network, the first product has a product ID within the first social network, and the first service has a service ID within the first social network. The system further includes a processor configured to map the first opinion data with the user ID and the commercial entity ID and the first product ID or the first service ID. The processor is configured to create data regarding a first sentiment group within the social network account of the commercial entity based on the mapped first opinion data. The first sentiment group provides an indication of a first sentiment of the user regarding the first product or first service. The processor is configured to assign the user ID to the first sentiment group data. The system includes a memory device configured to store the first sentiment group data.

In several implementations, the processor is configured to crawl one or more web pages to receive the first opinion data.

In various implementations, the processor is configured to determine a probability that the mapped opinion data applies to a second product or second service. The second product is assigned a second product ID and the second service is assigned a second service ID. The second product is offered by the commercial entity and the second service offered by the commercial entity. The processor is further configured to map the first opinion data with the user ID and the commercial entity ID and the second product ID or the second service ID upon determining that the probability exceeds a threshold. The processor is configured to create data regarding the first sentiment group within the social network account of the commercial entity based on the first opinion data that is mapped with the second product or second service.

In a number of implementations, the processor is configured to create instruction data to display a representation of the user with respect to a representation of the first sentiment.

These implementations may provide one or more of the following advantages. For example, provision of social groups that represent sentiments of users towards the commercial entity and/or products/services offered by the commercial entity helps the commercial entity to improve and/or maintain relationships with the users. Also, the users benefit in that their opinions are viewed in an orderly fashion by the commercial entity and may be responded to. It is a win-win situation for both the commercial entity and the users.

Other aspects will become apparent from the following detailed description, taken in conjunction with the accompanying drawings.

### BRIEF DESCRIPTION OF THE DRAWINGS

Various implementations of the present disclosure may best be understood by reference to the following description taken in conjunction with the accompanying drawings.

FIG. 1 is a block diagram of an architecture for managing social network relationships between one or more users and a commercial entity, in accordance with various implementations of the present disclosure.

FIG. 2 is a flowchart of a method for generating sentiment group data of a sentiment towards a first product/service and assigning a user identification (ID) to the sentiment group data, in accordance with several implementations of the present disclosure.

FIG. 3 is a block diagram of an architecture for crawling multiple web pages to obtain opinion data from various users, in accordance with various implementations of the present disclosure.

FIG. 4 is a diagram of a first web page that is crawled for obtaining data, in accordance with several implementations of the present disclosure.

FIG. 5 is a diagram of a second web page that is crawled for obtaining data, in accordance with various implementations of the disclosure.

FIG. 6 is a diagram of a third web page that is crawled for obtaining data, in accordance with several implementations of the disclosure.

FIG. 7 is a diagram of a fourth web page that is crawled for obtaining data, in accordance with various implementations of the present disclosure.

FIG. 8 is a diagram of a system that includes a facility to determine whether a user visited the facility, in accordance with various implementations of the present disclosure.

FIG. 9 is a diagram of a system that includes the facility to determine whether a user visited the facility, in accordance with several implementations of the present disclosure.

FIG. 10 is a diagram of a fifth web page that is crawled for obtaining data, in accordance with several implementations of the present disclosure.

FIG. 11 is a diagram of a web page that allows a user to conduct a multimedia chat with one or more other users, in accordance with several implementations of the present disclosure.

FIG. 12 is a block diagram of a sound recording device that records audio data during a multimedia chat of a user with one or more other users, in accordance with a number of implementations of the present disclosure.

FIG. 13 is a diagram of a web page that is displayed on a display screen of a client device when a user visits a social group web page that displays discrete sentiments of a user, in accordance with various implementations of the present disclosure.

FIG. 14 is a diagram of a web page that is displayed on a display screen of a client device when a user visits a social group web page that displays continuous sentiments of a user, in accordance with several implementations of the present disclosure.

FIG. 15 is a flowchart of various implementations of a method for assigning an identity of a user with a sentiment towards a second product/service based on an opinion of the user towards the first product/service and similarity between the first product/service with the second product/service, in accordance with various implementations of the present disclosure.

FIG. 16 is a block diagram of an architecture for managing social network relationships between one or more users and a commercial entity to illustrate creation of sentiment data associated with the second product/service, in accordance with several implementations of the present disclosure.

FIG. 17 is a diagram of a web page that is similar to the page of FIG. 13 except that the web page includes a social group that represents discrete sentiments of one or more users towards the second product/service, in accordance with various implementations of the present disclosure.

FIG. 18 is a diagram of a web page that is similar to the page of FIG. 14 except that the web page includes a social group that represents continuous sentiments of one or more users towards the second product/service, in accordance with various implementations of the present disclosure.

FIG. 19 is a flowchart of a method for reassigning a user ID from a representation of a first sentiment to a representation of a second sentiment, in accordance with several implementations of the present disclosure.

FIG. 20 is a block diagram of an architecture for managing social network relationships between one or more users and a commercial entity to illustrate a change in assignment of a user ID from first sentiment group data to second sentiment group data, in accordance with various implementations of the present disclosure.

FIG. 21 is a diagram of a web page that is displayed on a display screen of a client device to show representations of discrete sentiments of a user when an opinion of the user changes, in accordance with several implementations of the present disclosure.

FIG. 22 is a diagram of a web page that is displayed on a display screen of a client device to show representations of continuous sentiments of a user when an opinion of the user changes, in accordance with various implementations of the present disclosure.

FIG. 23 is a block diagram of a client device, in accordance with several implementations of the present disclosure.

### DETAILED DESCRIPTION

The following implementations describe systems and methods for generating notifications based on formation of memberships within a network.

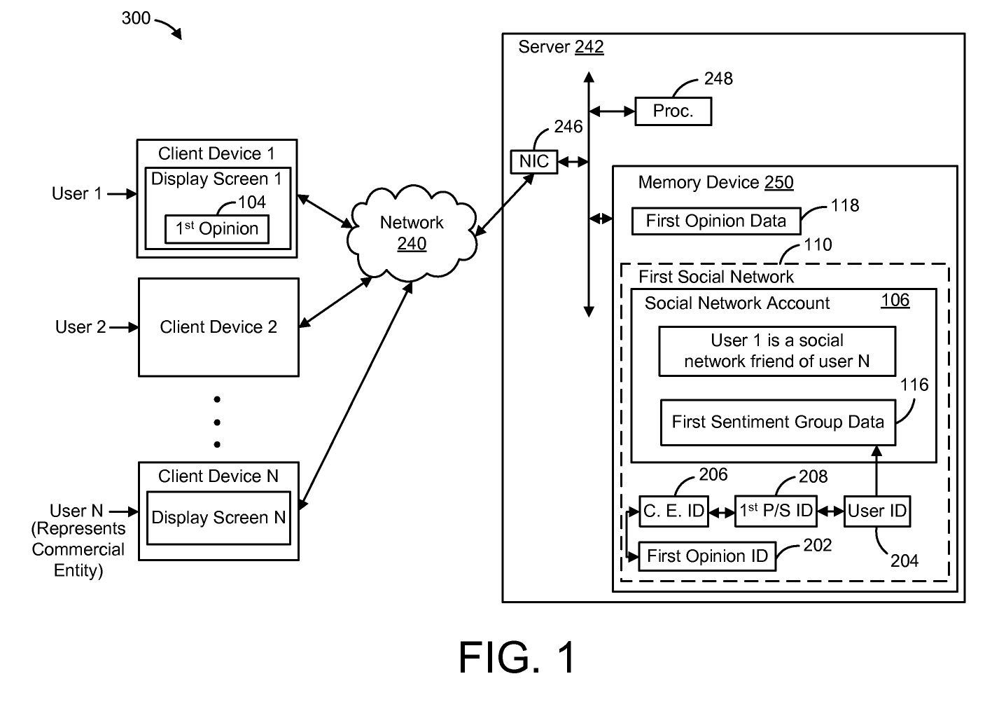

FIG. 1 is a block diagram of several implementations of an architecture 300 for managing social network relationships between one or more users 1 thru N−1 and a commercial entity that is represented by a user N, where N is an integer greater than one. The commercial entity is a business entity, e.g., a corporation, a partnership, a cooperation, a sole trader, a limited liability company, or another organization. The commercial entity and the users 1 thru N−1 are social network friends. For example, the users 1 thru N−1 have user accounts with a social network service and the commercial entity has a commercial entity account, e.g., a social network account 106, with the social network service. In this example, the users 1 thru N−1 choose to add the commercial entity via the user accounts of the users 1 thru N−1 as a friend or choose to follow the commercial entity. A user account is an account on the World Wide Web. The social network account 106 is a user account of the user N. In various implementations, the user N is an employee of the commercial entity or a consultant who is hired by the commercial entity.

As an illustration of adding the commercial entity via the user account 1, the user 1 logs into the user account 1 to receive access to a social network service. In this illustration, the user 1 selects via an input device of a client device 1 a multimedia that identifies the commercial entity and drags the multimedia with a social network group within the user account 1. Examples of a client device include a tablet, a desktop computer, a laptop computer, a cell phone, a smart phone, and a personal digital assistant. Also, examples of multimedia include an image, text, audio, video, and a combination thereof. Moreover, examples of an input device include a keyboard, a mouse, a touchpad, a stylus, and a touch screen that is integrated within a display screen. Examples of a display screen include a liquid crystal display screen (LCD), a light emitting diode (LED) display screen, a cathode ray tube (CRT) display screen, and a plasma display screen. When the multimedia is dragged to the social network group, the commercial entity is designated as a social network friend of the user 1 within the social network account 106.

As another illustration of adding the commercial entity via the user account 1, after logging into the user account 1 to receive access to social network service, the user 1 selects via the input device of the client device 1 a button to send a request to the commercial entity to add the commercial entity as a social network friend. The request is sent by a network interface controller (NIC) of the client device 1 via the network 240 and the server 242 to the client device N. When the user N logs into the social network account 106 via an input device of the client device N and selects a button displayed to accept the request, the commercial entity is designated as a social network friend of the user 1 within the social network account 106. Examples of a NIC include a network interface controller and a network adapter.

A social network service provides an online platform that focuses on facilitating building social graphs among the users 1 thru N. The users 1 thru N share interests, hobbies, activities, and/or backgrounds via the social network service. In various implementations, a user receives access to a social network by creating a user account that is protected by user information, e.g., a user name, a password, a user identification (ID), an electronic message address, a telephone, or other information identifying the user. An example of an identification includes alphanumeric characters, e.g., words. When the user information of a user is authenticated by a server, the user is provided access to a user account and to features of a social network service. Examples of features of a social network service include allowing a user to post multimedia in his/her user account to be accessible by other users, to receive multimedia within the user account, to chat with other users via the user account, to conduct a video conference with other users via the user account, and to conduct an audio conversation with other users via the user account. A server, as used herein, refers to a physical machine or a virtual machine. A social network service is provided when one or more processors of one or more servers execute a social network application. An application is a computer program that is stored on a computer-readable medium.

The users 1 thru N−1 receive access to various webpages at corresponding client device 1 thru N−1 via the network 240. Examples of the network 240 include a wired network, a combination of a wireless network and a wired network, a local area network (LAN), a wide area network (WAN), a combination of WAN and a LAN, the Internet, an Intranet, and a combination of the Internet and an Intranet. In several implementations, the network 240 allows access to the World Wide Web.

The users 1 thru N−1 express their opinions towards various products, services, and/or commercial entities, at the various webpages or by visiting a facility of the commercial entity. For example, the user 1 expresses his/her first opinion 104 by using the client device 1 and a social network service. To illustrate further, a user logs into his/her user account to receive access to a web page that allows the user to indicate whether the user likes or dislikes a product/service. In this illustration, the user selects via an input device of a client device a button displayed on the web page to indicate that he/she likes a product/service. In several implementations, the terms opinion and sentiment are used interchangeably herein.

Examples of a button displayed to allow the user to indicate that he/she likes a product/service include a like button and a “+1” button. Examples of a button displayed to allow a user to indicate that he/she dislikes a product/service include a dislike button and a “4” button. In several implementations, a button displayed on a web page is of other types, e.g., a somewhat like button, a more likely than not like button, a mildly like button, a mildly dislike button, a more likely than not dislike button, and a somewhat dislike button. A button, e.g., like button, somewhat like button, dislike button, etc., or a visitation to a facility of the commercial entity is used to express a structured opinion of a user regarding a product/service offered by the commercial entity. Examples of a facility of the commercial entity include a manufacturing plant of the commercial entity and a building that is owned or leased by the commercial entity to display its products/services to users. In several implementations, a processor 248 of the server 242 does not need to parse a structured opinion to determine a type of the opinion, e.g., whether the opinion is positive or negative.

As another example of a user providing his/her opinion regarding a product/service offered by the commercial entity, the user receives access to a web page. In this example, the web page has a comment field that allows the user to provide a comment on the product/service. Moreover, in this example, the user selects the comment field via an input device of a client device and provides a comment within the comment field. In this example, after providing the comment, the user selects a button that is displayed on the web page to share the comment with social network friends of the user or with other users. In several implementations, post and comment are used interchangeably herein.

As yet another example of provision of an opinion by a user regarding a product/service offered by the commercial entity, the user receives access to a web page. The web page has a field that when selected by the user via an input device of a client device allows the user to provide a post within the field. The post is regarding the product/service. After providing the post, the user selects an enter button or a post button that is displayed on the web page to share the post with social network friends of the user or with other users, e.g., public. As another example of provision of an opinion by a user regarding a product/service offered by the commercial entity, a user sends an electronic message to another user regarding the product/service. In various implementations, an electronic message is an email.

As another example of provision of an opinion by a user regarding a product/service offered by the commercial entity, a user conducts a multimedia chat with other users regarding the product/service. In this example, the user uses his/her user account to conduct the multimedia chat.

A comment regarding a product/service offered by the commercial entity, a post regarding the product/service, a mention of the product/service during a multimedia chat, and an electronic message regarding the product/service, are used to express unstructured opinions of a user regarding the product/service. In several implementations, the processor 248 parses and analyzes an unstructured opinion to determine the type of the opinion regarding a product/service offered by the commercial entity.

Examples of the first opinion 104 include like, somewhat like, more likely than not like, mildly like, mildly dislike, more likely than not dislike, somewhat dislike, and dislike. In several implementations, the terms like, satisfied, and positive are used interchangeably herein. In various implementations, the terms dislike, dissatisfied, and negative are used interchangeably herein.

Examples of products include products that are offered for sale or lease by the commercial entity. Some examples of products include shoes, clothes, foods, drinks, household items, electronic accessories, electronic items, etc. Examples of services are services that are offered by the commercial entity. Some examples of services include insurance services, house cleaning services, legal services, medical services, etc.

A NIC 246 of a server 242 receives information within the first opinion 104 as first opinion data 118 via the network 240 from the NIC of the client device 1. In various implementations, the first opinion data 118 is applied by a graphical processing unit (GPU) of the client device 1 to a rendering program to display the first opinion 104 on a display screen 1 of the client device 1. The rendering program is a computer program that is stored within a computer-readable medium.

The NIC 246 stores the first opinion data 118 within a memory device 250. A memory device includes a read-only memory (ROM), a random access memory (RAM), or a combination thereof. A memory device is an example of a computer-readable medium. Examples of a memory device include a flash memory and a hard disk.

The processor 248 associates, e.g., establishes a link between, the first opinion data 118 with a commercial entity ID 206 of the commercial entity, with a product/service ID 208 of a first product/service offered by the commercial entity, and a user ID 204 of the user 1 who provided the first opinion 104 regarding the first product/service. A processor, as used herein, includes an application specific integrated circuit (ASIC), a field programmable gate array (FPGA), a microprocessor, a controller, a processing unit, or a central processing unit (CPU).

In several implementations, the processor 248 maintains a database of user IDs, commercial entity IDs, and product/service IDs. The database is maintained within the memory device 250. A user ID identifies a user to distinguish the user from other users. For example, a first user ID identifies the user 1 and a second user ID identifies the user 2. In some implementations, a user ID includes the user information. A commercial ID distinguishes the commercial entity from other business entities. Also, a product ID distinguishes a product offered by the commercial entity from other products that are offered by the commercial entity and a service ID distinguishes a service offered by the commercial entity from other services that are offered by the commercial entity.

The processor 248 generates first sentiment group data 116 regarding the first product/service based on the association between the first opinion ID 202, the user ID 204, the commercial entity ID 206, and the first product/service ID 208. For example, when the first opinion data 118 indicates to the processor 248 that the user 1 has developed a positive opinion towards the first product/service offered by the commercial entity, the processor 248 creates the first sentiment group data 116 that represents the positive opinion and stores the first sentiment group data 116 within the social network account 106. As another example, when the first opinion data 118 indicates to the processor 248 that the user 1 has developed a negative opinion towards the first product/service, the processor 248 creates the first sentiment group data 116 that represents the negative opinion and stores the first sentiment group data 116 within the social network account 106.

The processor 246 assigns the user ID 204 to the first sentiment group data 116. For example, the processor 246 links the user ID 204 with the first sentiment group data 116. As another example, the processor 246 generates a database in which the first sentiment group data 116 and the user ID 204 are within a row of a table of the database.

The NIC 246 accesses the first sentiment group data 116 and the user ID 204 from the memory device 250 and sends the first sentiment group data 116 and the user ID 204 via the network 240 to the client device 1. The GPU of the client device 1 applies the rendering program to the first sentiment group data 116 and the user ID 204 to display a representation of a first sentiment group of one or more users on the display screen 1 and an identity of the user 1 in relation to the representation of the first sentiment group. For example, the GPU of the client device 1 displays a circle that represents the first sentiment group and a multimedia that identifies the user 1 within the circle. As another example, the GPU of the client device 1 displays a square that represents the first sentiment group and a multimedia that identifies the user 1 besides the square.

When the user N logs into the social network account 106, the user N views the representation of the first sentiment group and the multimedia of the user 1 with respect to the representation of the first sentiment group. In several implementations, the commercial entity implements, via the processor 248, a plan for marketing the first product/service to the user 1 based on a representation of a sentiment of the first sentiment group. The processor 248 determines data regarding an offer for selling or leasing the first product or selling the first service to the user 1 based on the first sentiment group. For example, when a sentiment of a sentiment group represents a negative opinion of the user 1 towards the first product/service, the processor 248 can generate data to offer deals, e.g., coupons, discounts, free items, to the user 1 via the user account 1. As another example, when a sentiment group represents a positive opinion of the user 1 towards the first product/service, the processor 248 determines not to generate data to offer deals towards purchasing or leasing the first product/service. As another example, when a sentiment group represents a positive opinion of the user 1 towards the first product/service, the processor 248 determines data to offer a lower number of deals towards purchasing or leasing the first product/service to the user 1 than when the user 1 has a negative opinion towards the first product/service. As yet another example, when a sentiment group represents a positive opinion of the user 1 towards the first product/service, the processor 248 determines data to offer different deals towards purchasing or leasing the first product/service to the user 1 than when the user 1 has a negative sentiment. For example, the processor 248 determines data to offer a lower discount for purchasing/leasing the first product to the user 1 when the user 1 has a positive opinion towards the first product/service than when the user 1 has a negative opinion towards the first product/service.

In various implementations, any data, e.g., data to offer a deal, that is received by a NIC of a client device from the server 242 via the network 240 is applied to the rendering program to display one or more graphical objects, e.g., multimedia, on a display screen. For example, a GPU of a client device applies the rendering program to data regarding a discount offer to display text on a display screen regarding the offer.

The social network account 106 and the user accounts of the users 1 thru 1−N are web accounts with a first social network 110. For example, the user accounts of the users 1 thru 1−N and the social network account 106 are accessed to allow use of features of the first social network 110. To provide an illustration of receiving access to a user account, a user logs into the user account to receive access to features of a social network service.

In several implementations, the first social network 110 is controlled by one entity. For example, an entity leases or purchases one or more servers to create the first social network 110, develops a social network application to provide a social network service via the first social network 110, or a combination thereof.

In a number of implementations, an opinion of a user is an opinion regarding the commercial entity rather than towards a product/service offered by the commercial entity. For example, the first opinion 104 is an opinion regarding the commercial entity rather than the first product/service. In this example, instead of the association between the first opinion ID 202, the user ID 204, the commercial entity ID 206, and the first product/service ID 208, an association between the commercial entity ID 206, the first opinion ID 202, and the user ID 204 is established by the processor 248. Also, in this example, the first sentiment group data 116 is created based on the association between the commercial entity ID 206, the first opinion ID 202, and the user ID 204. To illustrate further, when the first opinion data 118 indicates to the processor 248 that the user 1 has developed a positive opinion towards the commercial entity, the processor 248 creates the first sentiment group data 116 that represents the positive opinion and stores the first sentiment group data 116 within the social network account 106. As another illustration, when the first opinion data 118 indicates to the processor 248 that the user 1 has developed a negative opinion towards the commercial entity, the processor 248 creates the first sentiment group data 116 that represents the negative opinion and stores the first sentiment group data 116 within the social network account 106.

In various implementations, instead of one, any number of memory devices is used to store data, e.g., the first opinion data 118, the social network account 106, the commercial entity ID 206, the first product/service ID 208, the user ID 204, and the first opinion ID 202. Also, in various implementations, instead of one processor, any number of processors performs operations that are described herein as performed by the processor 248. Also, in a number of implementations, instead of one server 242, any number of servers performs operations that are described herein as performed by the server 242.

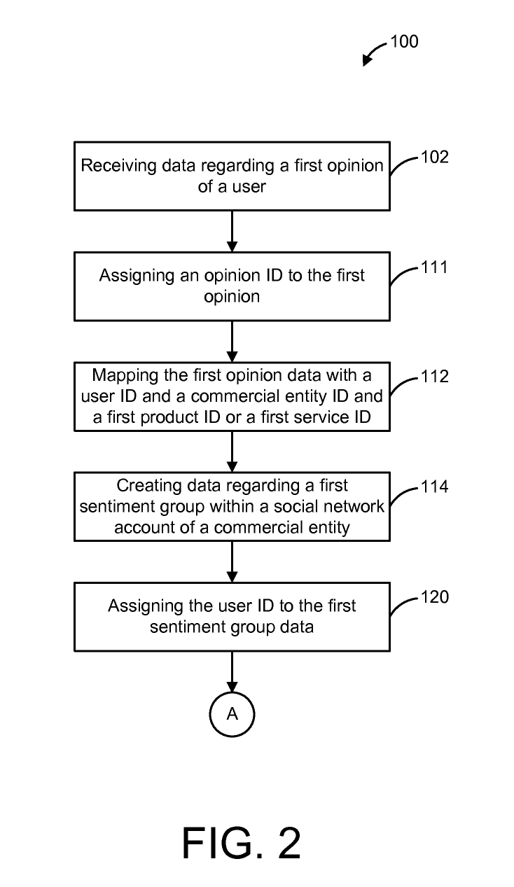

FIG. 2 is a flowchart of various implementations of a method 100 for generating sentiment group data and assigning a user ID to the sentiment group data. The method 100 is executed by one or more processors, e.g., processor 248 (FIG. 1), of one or more servers.

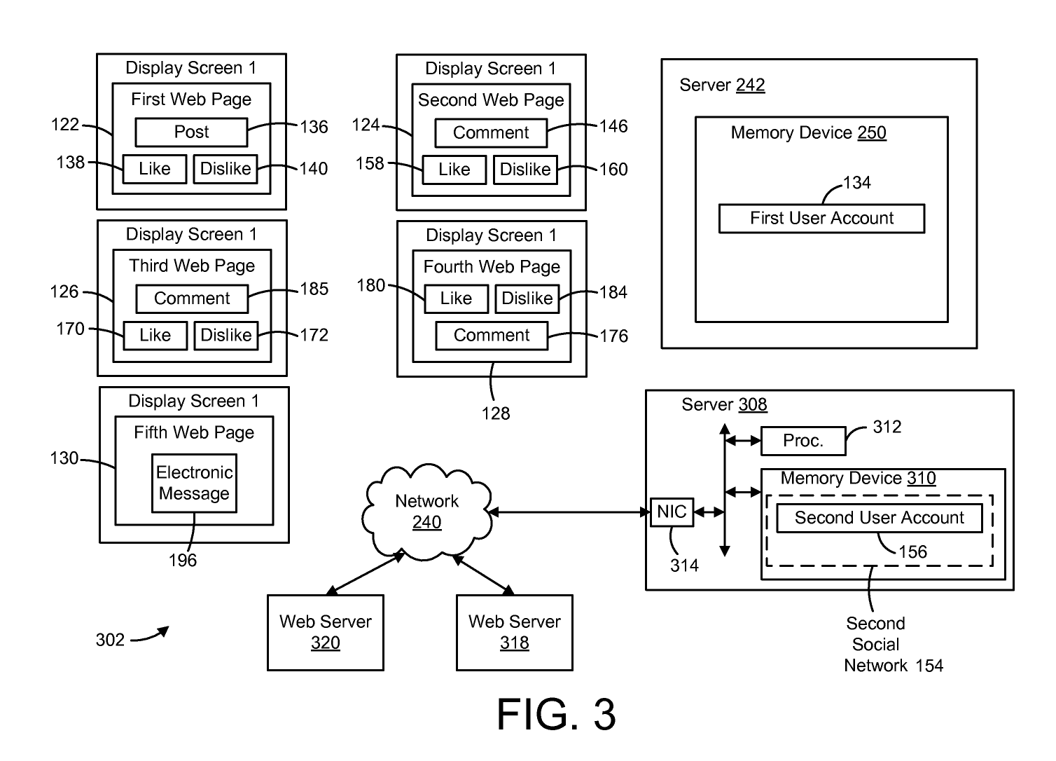

In an operation 102, the NIC 246 receives the first opinion data 118 via the network 240 from the NIC of the client device 1 (FIG. 1). The first opinion data 118 is received when the processor 248 crawls one or more web pages that are displayed at the display screen 1. For example, the processor 248 sends an instruction to a processor of the client device 1 via the network 240 to send web page data to the server 242. Examples of the one or more web pages that are crawled are provided below with reference to FIGS. 3-7 and 10. Upon receiving the instruction, the processor of the client device 1 sends data of a web page that is displayed on the display screen 1 via the network 240 to the NIC 246. Upon receiving the web page data from the NIC 246, the processor 248 stores the web page data within the memory device 250.

In an operation 111, the first opinion ID 202 (FIG. 1) is assigned to the first opinion data 118. For example, the processor 248 generates bits that represent an alphanumeric character to generate the first opinion ID 202, and identifies the first opinion data 118 with the first opinion ID 202.

In an operation 112, the first opinion data 118 is mapped with the user ID 204, the commercial entity ID 206, and the first product/service ID 208 (FIG. 1). For example, the processor 248 creates an association, e.g. a relationship or a link, between the first opinion ID 202, the user ID 204, the commercial entity ID 206, and the first product/service ID 208. As another example, the processor 248 stores the first opinion ID 202, the user ID 204, the commercial entity ID 206, and the first product/service ID 208 within a row of a table within a database.

In an operation 114, the first sentiment group data 116 (FIG. 1) is created within the social network account 106 of the commercial entity based on the first opinion data 118 having the first opinion ID 202 that is mapped with the user ID 204, the commercial entity ID 206, and the first product/service ID 208. For example, if the first opinion data 118 indicates that the user 1 likes the first product/service, the processor 248 generates positive sentiment data as the first sentiment group data 116. In this example, the user 1 selects a like icon that is displayed within a web page on the display screen 1 (FIG. 1). As another example, if the first opinion data 118 indicates that the user 1 somewhat likes the first product/service, the processor 248 generates somewhat positive sentiment data as the first sentiment group data 116. In this example, the user 1 commented within a post on a web page of a social network service that the user 1 likes the first product/service but also commented that a quality of the first product/service is inconsistent.

As yet another example, if the first opinion data 118 indicates that the user 1 dislikes the first product/service, the processor 248 generates negative sentiment data as the first sentiment group data 116. In this example, the user 1 selects a dislike icon that is displayed within a web page on the display screen 1 (FIG. 1). As another example, if the first opinion data 118 indicates that the user 1 somewhat dislikes the first product/service, the processor 248 generates somewhat negative sentiment data as the first sentiment group data 116. In this example, the user 1 commented within a post on a web page of a social network service that the user 1 dislikes the first product/service but also commented that sometimes the user 1 liked the first product/service. As yet another example, if the first opinion data 118 indicates that the user 1 somewhat dislikes the first product/service, the processor 248 generates somewhat negative sentiment data as the first sentiment group data 116. In this example, the user 1 commented within a post on a web page of a social network service that the user 1 dislikes the first product/service but also commented that are some parts of the first product/service that the user 1 likes. Examples of a part of a product include a color of the product, a taste of the product, a look of the product, a feel of the product, or a combination thereof. Examples of a part of a service include a time period during which the service is offered, a geographic location at which the service is offered, attitude of people that offer the service, timeliness of the service, quality of the service, or a combination thereof. Each of positive sentiment data, somewhat positive sentiment data, somewhat negative sentiment data, and negative sentiment data is a type of the first sentiment group data 116.

In several implementations, the processor 248 generates any number of types of the first sentiment group data 116. For example, the processor 248 generates positive sentiment data, somewhat positive sentiment data, mildly positive sentiment data, mildly negative sentiment data, somewhat negative sentiment data, and negative sentiment data. In this example, the somewhat positive sentiment data is less positive than the positive sentiment data, the mildly positive sentiment data is less than positive than the somewhat positive sentiment data, the mildly negative sentiment data is more negative than the somewhat positive sentiment data and more positive than the somewhat negative sentiment data, and the somewhat negative sentiment data is more negative than the negative sentiment data.

As another example, the processor 248 generates positive sentiment data, somewhat positive sentiment data, more likely than not positive sentiment data, mildly positive sentiment data, mildly negative sentiment data, more likely than not negative sentiment data, somewhat negative sentiment data, and negative sentiment data. In this example, the somewhat positive sentiment data is less positive than the positive sentiment data, the more likely than not positive sentiment data is less positive than the somewhat positive sentiment data, the mildly positive sentiment data is less positive than the more likely than not positive sentiment data, the mildly negative sentiment data is more negative than the mildly positive sentiment data and more positive than the somewhat negative sentiment data, the more likely than not negative sentiment data is more negative than the mildly negative sentiment data, the somewhat negative sentiment data is more negative than the more likely than not negative sentiment data, and the negative sentiment data is more negative than the somewhat negative sentiment data.

The processor 242 also generates an instruction regarding a type of representation of the first sentiment group data 116. For example, the instruction indicates to the GPU of the client device 1 to display the first group sentiment data 116 using words, e.g., “positive sentiment”, “somewhat positive sentiment”, “more likely than not positive sentiment”, “mildly positive sentiment”, “mildly negative sentiment”, “more likely than not negative sentiment”, “somewhat negative sentiment”, and “negative sentiment”. In this example, the words “positive sentiment” are displayed when a GPU of the client device N applies the rendering program to the positive sentiment data, the words “somewhat positive sentiment” are displayed when the GPU applies the rendering program to the somewhat positive sentiment data, the words “more likely than not positive sentiment” are displayed when the GPU applies the rendering program to the more likely than not positive sentiment data, and the words “mildly positive sentiment” are displayed when the GPU applies the rendering program to the mildly positive sentiment data. Moreover, in this example, the words “mildly negative sentiment” are displayed when the GPU applies the rendering program to the mildly negative sentiment data, the words “more likely than not negative sentiment” are displayed when the GPU applies the rendering program to the more likely than not negative sentiment data, the words “somewhat negative sentiment” are displayed when the GPU applies the rendering program to the somewhat negative sentiment data, and the words “negative sentiment” are displayed when the GPU applies the rendering program to the negative sentiment data.

As another example, instead of words, the instruction indicates to the GPU of the client device N to display the first group sentiment data 116 using numerical characters, e.g., “1”, “2”, “3”, “4”, “5”, “6”, “7”, and “8”. In this example, the number “1” is displayed when the GPU applies the rendering program to the positive sentiment data, the number “2” is displayed when the GPU applies the rendering program to the somewhat positive sentiment data, the number “3” is displayed when the GPU applies the rendering program to the more likely than not positive sentiment data, the number “4” is displayed when the GPU applies the rendering program to the mildly positive sentiment data. Moreover, in this example, the number “5” is displayed when the GPU applies the rendering program to the mildly negative sentiment data, the number “6” is displayed when the GPU applies the rendering program to the more likely than not negative sentiment data, the number “7” is displayed when the GPU applies the rendering program to the somewhat negative sentiment data, and the number “8” is displayed when the GPU applies the rendering program to the negative sentiment data.

It should be noted that a representation of sentiment data is not limited to that described above. For example, instead of “positive sentiment”, another group of words, e.g., “like” or “satisfied”, is displayed. As another example, instead of the words “negative sentiment”, another group of words, e.g., “dislike” or “unsatisfied”, are displayed. As yet another example, instead of the numbers “1”, “2”, “3” and so on, alphabetical characters, e.g. “A”, “B”, “C”, “D” and so on are displayed. In various implementations, the terms sentiment group data and sentiment data are used interchangeably herein.

The numerical characters provide a continuous representation of various sentiments of the user 1. For example, there is no integer between “1” and “2” that represents a sentiment of the user 1 that is less positive than the positive sentiment and more positive than the somewhat positive sentiment. As another example, there is no integer between “7” and “8” that represents a sentiment of the user 1 that is less negative than the negative sentiment and more positive than the somewhat negative sentiment.

On the other hand, the words provide a discrete representation of various sentiment of the user 1. For example, there exists a type of sentiment of the user 1 between the “positive sentiment” and the “somewhat positive sentiment”. As another example, there exists a type of sentiment of the user 1 between the “mildly negative sentiment” and the “more likely than not negative sentiment”.

The alphanumeric characters indicate to the user N a sentiment of one or more of the users 1 thru N−1. For example, when the number “1” is displayed on the display screen of the client device N, the number indicates to the commercial entity that one or more of the users 1 thru N−1 like the first product/service. As another example, when the words “more likely than not positive sentiment” is displayed on the display screen of the client device N, the words indicate to the commercial entity that one or more of the users 1 thru N have a higher amount of positive sentiment towards the first product/service than an amount of negative sentiment towards the first product/service.

The processor 248 assigns a sentiment group ID to the first sentiment group data 116. For example, the processor 248 generates an identification that is used to distinguish the first sentiment group data 116 from other sentiment group data that is generated from other opinions of the one or more users 1 thru N−1.

In an operation 120, the user ID 204 is assigned to the first sentiment group data 116. For example, the processor 248 associates the user ID 204 with the sentiment group ID of the first sentiment group data 116. As another example, the processor 248 maintains a table in which the user ID 204 is in the same row as that of the sentiment group ID of the first sentiment group data 116. The table is maintained within the memory device 250. As another example, the processor 248 maintains a table in which the user ID 204 is in the same row as that of the sentiment group ID of the first sentiment group data 116, the commercial entity ID 206, the first product/service ID 208, and the first opinion ID 202. In various implementations, the method 110 ends after the operation 120.

When the user 2 provides an opinion regarding the first product/service, the processor 248 determines whether data of the opinion is the same as that of the first opinion data 118 of the user 1. As an example, when the user 2 provides a structured opinion regarding the first product/service, the processor 248 determines whether data of the opinion of the user 2 is the same as that of data of the first opinion data 118, which is data of a structured opinion of the user 1. To further illustrate, when the user 2 selects a like icon on a web page that is displayed on the client device 2 and the user 1 selects a like icon on a web page that is displayed on the client device 1, the processor 248 determines that the opinions of the users 1 and 2 are the same. As yet another illustration, when the user 1 selects a first number of like buttons on one or more web pages that are displayed on the display screen 1 and the user 2 selects a second number of like buttons on one or more web pages that are displayed on the display screen 2, the processor 248 determines whether the first number is equal to the second number or within the threshold. In this example, upon determining that the first number is equal to the second number or within the threshold, the processor 248 determines that opinions of the users 1 and 2 are the same. As another illustration, when the user 1 visits a facility of the commercial entity for a first number of times and the user 2 visits a facility of the commercial entity for a second number of times, the processor 248 determines whether the first number is the same as the second number or within the threshold. In response to determining that the first and second numbers are the same or that the first number is within the threshold, the processor 248 determines that the opinions of the users 1 and 2 regarding the first product/service are the same.

As another example, when the user 2 provides an unstructured opinion regarding the first product/service, the processor 248 determines whether data of the opinion of the user 2 is the same as that of the first opinion data 118, which is data of an unstructured opinion of the user 1. To further illustrate, when the user 1 makes a first number of positive statements regarding the first product/service in a post or a comment that is displayed on a web page on the client device 1 and the user 2 makes a second number of positive statements regarding the first product/service in a post or a comment that is displayed on a web page on the client device 2, the processor 248 determines that the first opinion data 118 is the same as that of data of the opinion provided by the user 2. In several implementations, the first number is a majority and the second number is a majority. In various implementations, the first number is within a threshold of the second number. In a number of implementations, a statement is a sentence that is separated from another sentence by identification marks, e.g., a comma, a period, or a semi-colon.

In response to determining that the data of the opinion of the user 2 regarding the first product/service is the same as that of the first opinion data 118, the processor 248 assigns a user ID of the user 2 to the first sentiment group data 116. The NIC 246 sends the user ID of the user 2 with an instruction to display the user ID with respect to the representation of the first sentiment group data 116. Upon receiving the instruction via the network 240, the GPU of the client device N displays the user ID with respect to the representation of the first sentiment group data 116.

On the other hand, in response to determining that the data of the opinion of the user 2 regarding the first product/service is not the same as that of the first opinion data 118, the processor 248 generates sentiment group data based on the opinion of the user 2. The sentiment group data that is generated based on the opinion of the user 2 is generated in a manner similar to that of generation of the first sentiment group data 116 based on the first opinion 104. For example, the processor 248 generates the sentiment group data corresponding to the opinion of the user 2 based on an association between an opinion ID of the opinion, a user ID of the user 2, the commercial entity ID 206, and the first product/service ID 208. As another example, when an opinion of the user 2 is negative towards the first product/service, the processor 248 generates sentiment group data that is used to represent a negative sentiment of the user 2. Also, a user ID of the user 2 is assigned to sentiment group data that is generated based on an opinion of the user 2 in a similar manner as that of the operation 120. For example, sentiment group data that is generated based on an opinion of the user 2 is linked with a user ID of the user 2. The sentiment group data that is generated based on an opinion of the user 2 is stored within the social network account 106.

Moreover, sentiment group data and a user ID of the user 2 are sent by the NIC 246 via the network 240 to the client device N. When the user N receives access to the social network account 106 via the client device N, a representation of sentiment group data that is generated based on an opinion of the user 2 is displayed by the GPU of the client device N with respect to an identity of the user 2. A representation of sentiment group data generated based on an opinion of the user 2 with respect to an identity of the user 2 is similar to that of a representation of the first sentiment group data 116 with respect to an identity of the user 1.

It should be noted that in the implementations in which the first opinion 104 is regarding the commercial entity rather than regarding the first product/service, in the operation 112, the first opinion data 118 is mapped with the user ID 204 and the commercial entity ID 206. There is a lack of mapping of the first opinion data 118 with the first product/service ID 208. Moreover, in the operation 114, the first sentiment group data 116 (FIG. 1) is created within the social network account 106 of the commercial entity based on the first opinion data 118 having the first opinion ID 202 that is mapped with the user ID 204 and the commercial entity ID 206.

FIG. 3 is a block diagram of several implementations of an architecture 302 for crawling multiple web pages to obtain opinion data from various users 1 thru N−1 (FIG. 1). The processor 248 (FIG. 1) crawls a first web page that is displayed on the display screen 1. The user 1 receives access to a first user account 134 of the user 1. The first user account 134 is stored within the memory device 250 of the server 242, which is used by an entity to provide a social network service. The first user account 134 is a user account within the first social network 110 (FIG. 1). For example, the user 134 receives access to the first social network 110 after the user information is authenticated by an authentication server (not shown). In this example, when the user information is authenticated, the processor 248 (FIG. 1) provides access to features of a social network service to the user 1.

The first web page 122 includes a post 136 that is posted by the user 1 and a like button 138 and a dislike button 140. The user 1 provides the post 136 via the input device of the client device 1 and selects a button to share the post 136 with social network friends of the first social network 110. The user 1 may have selected the like button 138 or the unlike button 140 to express his/her opinion regarding the first product/service. The post 136 includes an opinion of the user 1 regarding the first product/service. The processor 248 crawls the first web page 122 to copy data of the first web page 248. The processor 248 copies the data of the first web page 248, e.g., data of the post 136, data indicating a selection of the like button 138, data indicating a selection of the dislike button 140, etc., to store the data within the memory device 250.

The user 1 receives access to a second web page 124 by logging into a second user account 156 that is stored within a memory device 310 of a server 308. The client device 1 (FIG. 1) requests the second web page 124 via the network 240 from the server 308. Upon receiving the request, a processor 312 of the server 308 instructs a NIC 314 of the server 308 to send data of the second web page 124 via the network 240 to the NIC of the client device 1. The data of the second web page 124 is sent to the client device 1 to allow the user 1 access to the web page 124.

The second user account 56 is stored within a second social network 154, which is different than the first social network 110 (FIG. 1). For example, an entity provides a social network service to the user 1 via the first user account 134 and another entity provides another social network service to the user 1 via the second user account 156. As another example, a first application is executed by the processor 242 to provide a social network service using the first social network 110 to one or more of the users 1 thru N and a second application is executed by the processor 312 to provide a social network service using the second social network 154 to one or more of the users 1 thru N.

The second web page 124 includes a comment 146 that is provided by the user 1. The second web page 124 also includes a like button 158 and a dislike button 160. The user 1 may select the like button 158 or the dislike button 160 to express his/her opinion regarding the first product/service. Moreover, the comment 146 may be made by the user 1 to express his/her opinion regarding the first product/service. The user 1 provides the comment 146 via the input device of the client device 1 and selects a button to share the comment 146 with social network friends of the second social network 154.

The processor 248 crawls the second web page 124 to copy data of the second web page 248. The processor 248 copies the data of the second web page 124, e.g., data within the comment 146, data indicating a selection of the like button 158, and data indicating a selection of the dislike button 160, to store the data within the memory device 250.

When the user 1 sends a request for a third web page 126 via the network 240 to a web server 318, the third web page 126 is displayed on the display screen 1. In several implementations, the third web page 126 is managed by the commercial entity. For example, the commercial entity pays for costs associated with creating and/or updating the third web page 126 on the web server 318. In various implementations, the third web page 126 provides a description by the commercial entity of the first product/service. For example, an employee or a consultant of the commercial entity creates the description of the first product/service that is displayed on the third web page 126.

The third web page 126 includes a comment button 185, a like button 170 and a dislike button 172. The comment button 185, like button 170, or the dislike button 172 may be selected by the user 1 to express his/her comment regarding the first product/service.

The user 1 receives access to the third web page 126 and selects either the comment button 185, the like button 170, or the dislike button 172 via the input device of the client device 1. When the user 1 selects the comment button 185, the like button 170, or the dislike button 172, the GPU of the client device 1 displays a prompt to allow the user 1 to access the first social network 110 or the second social network 154. The user 1 provides the user information to receive access to the first social network 110 or the second social network 154. Upon obtaining access to the first social network 110 or the second social network 154, the user 1 selects the comment button 185, the like button 170, and/or the dislike button 172. When the user 1 selects the comment button 185, a comment field is provided on the third web page 126 and the user 1 can provide his/her comment to express his/her opinion regarding the first product/service. After providing the comment, the user 1 selects another button that is displayed on the third web page 126 to share the comment with social network friends of the user 1.

The processor 248 crawls the third web page 126 to copy data of the third web page 126. The processor 248 copies the data of the third web page 126, e.g., data of the comment provided on the third web page 126, data indicating a selection of the like button 170, data indicating a selection of the dislike button 172, etc., to store the data within the memory device 250.

When the user 1 sends a request for a fourth web page 128 via the network 240 to a web server 320, the fourth web page 128 is displayed on the display screen 1. The fourth web page 128 is displayed on the display screen 1 to allow the user 1 access to the fourth web page 128. The fourth web page 128 includes a comment button 176, a like button 180, and a dislike button 184. The comment button 176 is provided by the user 1 to express an opinion regarding the first product/service. Moreover, the user 1 may select the like button 180 and/or the dislike button 184 to express his/her opinion regarding the first product/service.

In several implementations, the fourth web page 128 is managed by an entity other than the commercial entity. For example, the fourth web page 128 is managed by an entity that provides news coverage or that provides a combination of a search engine and a news coverage to the users 1 thru N. In other implementations, the fourth web page 128 is managed by the commercial entity. In various implementations, a major portion of the fourth web page 128 includes news and a minor portion includes advertisements. For example, the fourth web page 128 includes an advertisement regarding the first product/service to entice the users 1 thru N−1 to purchase or lease the first product or to purchase the first service.

The processor 248 crawls the fourth web page 128 to copy data of the fourth web page 128. The processor 248 copies the data of the fourth web page 128, e.g., data within a comment provided by the user 1 after selecting the comment button 185, data indicating a selection of the like button 180, data indicating a selection of the dislike button 184, etc., to store the data within the memory device 250.

The client device 1 displays the fifth web page 130 on the display screen 1 upon accessing data of the fifth web page 130 from a server, e.g., the server 242 or another server. In various implementations, the fifth web page 130 is managed by an entity that manages the first web page 122 or that manages the second web page 124. For example, the user 1 provides the user information to receive access via the first user account 134 to the first web page 122 and the fifth web page 130. As another example, the user 1 provides the user information to receive access via the second user account 154 to the second web page 124 and the fifth web page 130. In various implementations, the fifth web page 130 is managed by an entity that is other than an entity that manages the first web page 122 and other than an entity that manages the second web page 124. For example, the user 1 provides the user information to a web server (not shown) and upon authentication by the web server, the user 1 receives access to an electronic message service that is provided by the other entity.

The fifth web page 130 is displayed when an electronic message application is executed by a server, e.g., the server 242 (FIG. 1) or another server. The electronic message application is executed to provide an electronic messaging service at a client device. When the electronic messaging service is provided, electronic messages communicated between the user 1 and the other users 2 thru N−1 are displayed on the display screen 1.

The fifth web page 130 includes an electronic message 196. The electronic message 196 includes an opinion of the user 1 regarding the first product/service. In various implementations, the fifth web page 130 lists electronic messages that are communicated between the user 1 and one or more of other users 2 thru N−1. In several implementations, the fifth web page 130 lists a time at which the electronic messages are communicated and/or a date on which the electronic messages are communicated.

The electronic message 196 includes a subject line that is selected by the user 1 via the input device of the client device 1 to receive access to a body of the electronic message 196. In several implementations, the body of the electronic message 196 is displayed on a separate web page than the fifth web page 130. The processor 248 crawls the subject line and/or the body of the electronic message 196 to copy data from the subject line and/or the body.

Although each of the first web page 122, the second web page 124, the third web page 126, and the fourth web page 128 includes a post or comment field, a like button, and a dislike button, in several implementations, any of the first web page 122, the second web page 124, the third web page 126, and the fourth web page 128 includes one or more of a comment field, a like button, and a dislike button. For example, the first web page 122 includes the post 136 and excludes the like button 138 and excludes the dislike button 140.

It should be noted that although the same display screen 1 is used to illustrate various web pages, in several implementations, each web page is displayed on a different screen or accessed by a different client device. For example, the first web page 122 is displayed on the display screen 1 and the second web page 124 is displayed on a display screen of the client device 2. As another example, the first web page 122 is displayed on the display screen 1, the second web page 124 is displayed on a display screen of the client device 2, and the third web page 126 is displayed on a display screen of the client device 3.

In various implementations, some web pages are displayed on a display screen or accessed by a client device and other web pages are displayed on other display screens or accessed by other client devices. For example, the first web page 122 is displayed on the display screen 1, the second web page 124 is displayed on a display screen 1, and the third web page 126 is displayed on a display screen of the client device 2.

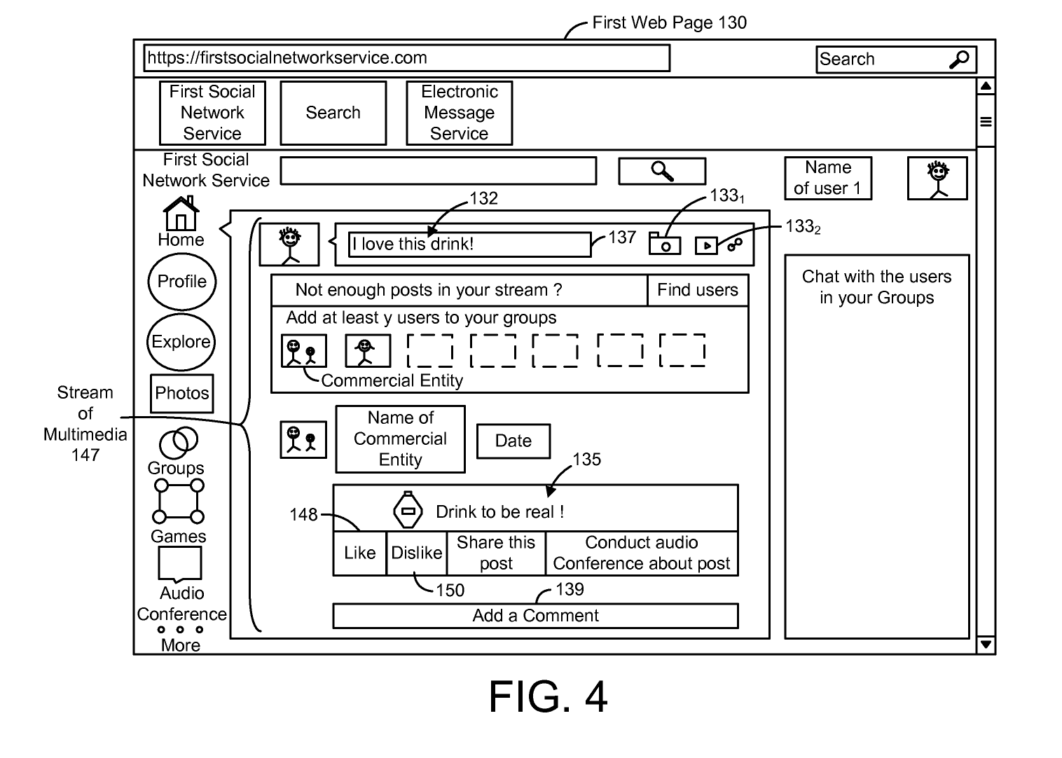

FIG. 4 is a diagram of various implementations of a first web page 130, which is an example of the first web page 122 (FIG. 3). The first web page 130 includes features of the first social network service 110 (FIG. 1). For example, the user 1 may chat with social network friends of the user 1 by selecting a button that includes “Chat with users in your Groups”. As another example, the user 1 can provide a post 132 in a post field 137 of the first web page 122. The user 1 provides the post 132 via the input device of the client device 1. Examples of the post 132 includes text. The post 132 includes an opinion of the user 1 regarding a drink, which is an example of the first product. In addition to providing the post 132, the user 1 may select a button 133₁ to upload an image to the server 242 (FIG. 1) or may select another button 133₂ to upload a video to the server 242. The image and the video may include an opinion of the user 1 regarding the drink. After providing the post, the user 1 selects a button, e.g., a share post button, a share button, a post button, etc., to share the post 132 with social network friends of the user 1.

Also, the first web page 130 includes a comment 135 from the commercial entity. The user 1 may select a like button 148 or a dislike button 150 via the input device of the client device 1 to express his/her opinion regarding the drink and/or the comment 135. The user 1 may provide a comment within a comment field 139 to express his/her opinion regarding the first product/service.

The post 132, the comment 135, the like button 148, the dislike button 150 and other multimedia that is communicated between the first user account 134 (FIG. 3) of the user 1 and other user accounts of other users are portions of a stream 147 of multimedia. In several implementations, a stream of multimedia organizes posts, comments, and/or other multimedia based on time. For example, a post that is shared the latest by the user 1 is displayed on top of the first web page 130 compared to a comment that is shared before the post is shared.

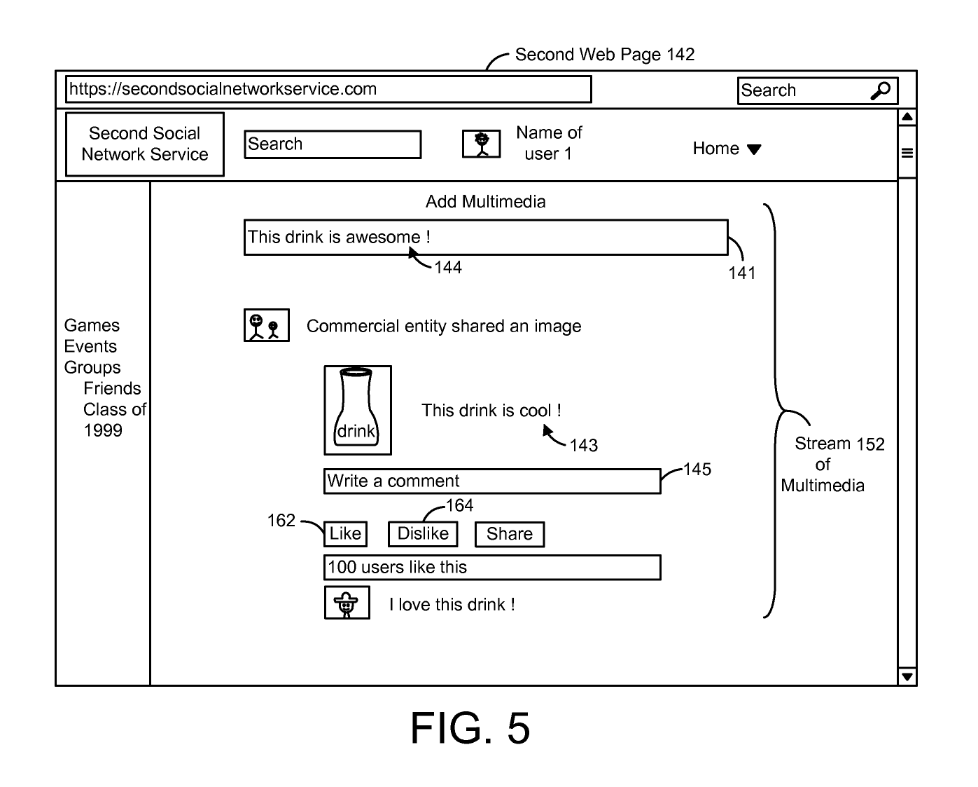

FIG. 5 is a diagram of various implementations of a second web page 142, which is an example of the second web page 124 (FIG. 3). The second web page 142 includes a comment field 141. The user 1 provides a comment 144 within the comment field regarding the drink. Moreover, the commercial entity shares an image and a post 143 with the second user account 156 (FIG. 3) of the user 1 via the social network account 106 (FIG. 1). The user 1 may provide a comment in a comment field 145 to respond to the post 143 and the image shared by the commercial entity to express his/her opinion regarding the drink. The user 1 may select a like button 162 and/or a dislike button 164 to express his/her opinion regarding the drink and/or the comment 143. The comment 144, the post 143, the like button 162, the dislike button 164 are portions of a stream 152 of multimedia.

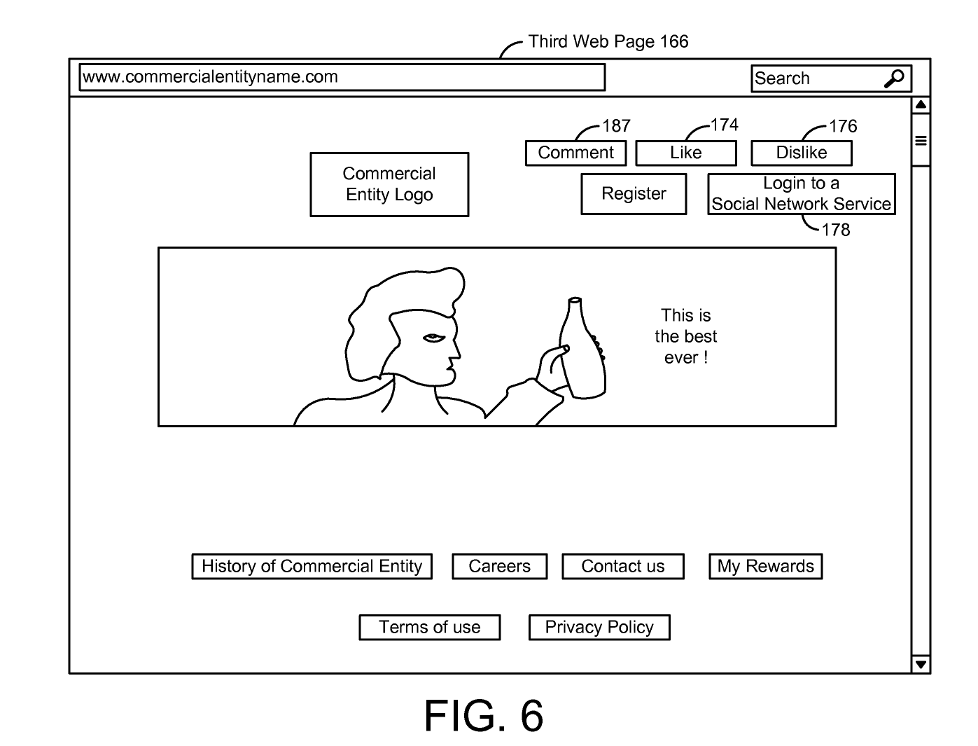

FIG. 6 is a diagram of various implementations of a third web page 166, which is an example of the third web page 126 (FIG. 3). It should be noted that the third web page 166 excludes an identity of the user 1 unless the user 1 logs into a social network service via the web page 166.

The third web page 166 includes a like button 174, a dislike button 176, and a comment button 187. When the like button 174, the dislike button 176, or the comment button 187 is selected by the user 1 via the input device of the client device 1, a prompt is displayed on the third web page 166 to allow the user 1 to provide the user information. In response to receiving the user information and authenticating the user information, the user 1 logs into a social network service, e.g., one provided using the first social network 110 (FIG. 1) or the second social network 154 (FIG. 3). The user 1 selects the like button 174 or the dislike button 176 again after the login to express his/her opinion regarding the drink. The user 1 may select the comment button 187 again to provide a comment to express his/her opinion regarding the drink and share the comment with social network friends of the user 1.

In various implementations, the user 1 selects a login button 178 to log into a social network service that is provided by the first social network 110 or the second social network 154 and then selects the like button 174, the dislike button 176, or the comment button 187 to express his/her opinion regarding the drink.

When the user 1 expresses his/her opinion by using a social network service that is provided by the first social network 110, the data of the opinion is stored within the first user account 134 (FIG. 3). Similarly, when the user 1 expresses his/her opinion by using a social network service that is provided by the second social network 154, data of the opinion is stored within the second user account 156 (FIG. 3).

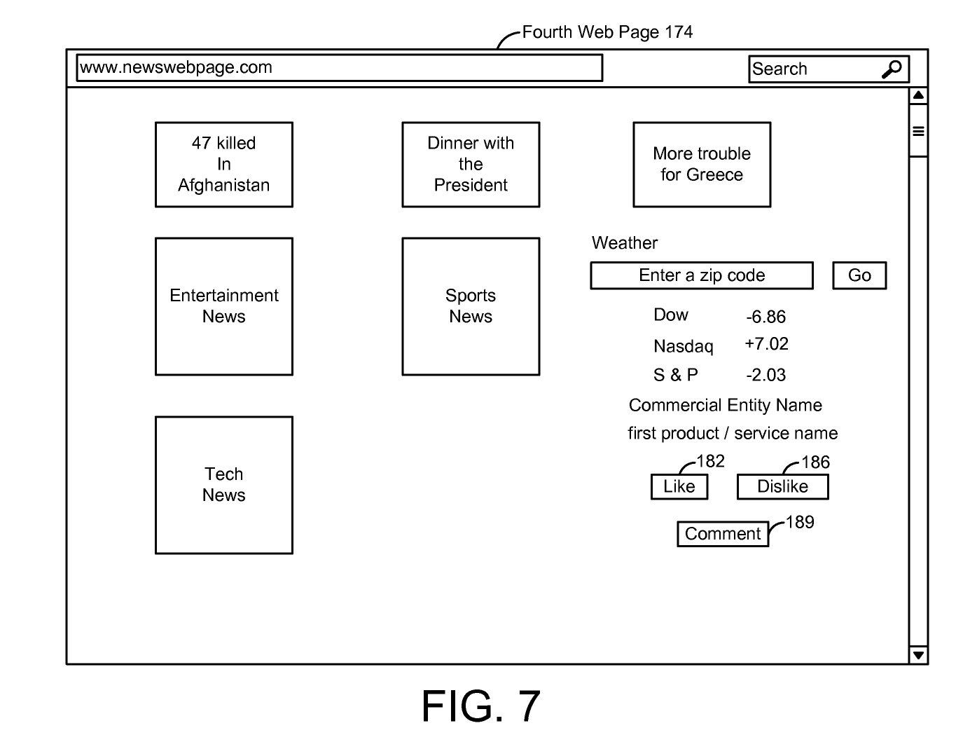

FIG. 7 is a diagram of various implementations of a fourth web page 134, which is an example of the fourth web page 128 (FIG. 3). The fourth web page 134 includes news regarding various geographic regions of the world. Examples of news include news regarding sports, news regarding entertainment, news regarding politics, news regarding weather, and news regarding finance. In several implementations, the fourth web page 134 includes one or more advertisements. For example, an entity that manages a social network service advertises the social network service on the fourth web page 134. As another example, a multimedia that identifies the first product/service is displayed on the fourth web page 134 to advertise the first product/service on the fourth web page 134.

The fourth web page 134 includes a like button 182, a dislike button 186, and a comment button 189. When the like button 182, the dislike button 186, or the comment button 189 is selected by the user 1 via the input device of the client device 1, a prompt is displayed on the fourth web page 128 to allow the user 1 to provide the user information. In response to receiving the user information and authenticating the user information, the user 1 logs into a social network service, e.g., one provided by the first social network 110 (FIG. 1) or the second social network 154 (FIG. 3). The user 1 selects the like button 182, the dislike button 186, or the comment button 189 again after the login to express his/her opinion regarding the drink.

It should be noted that the fourth web page 134 excludes any identity of the user 1 unless the user 1 logs into a social network service via the fourth web page 134. For example, when the user 1 visits the fourth web page 134, the fourth web page 134 excludes a name of the user 1 or an image of the user 1. When the user 1 logs into a social network service after selecting the like button 182 or the dislike button 186 or the comment button 189, a name of the user 1 and/or an image of the user 1 is displayed on the fourth web page 134.

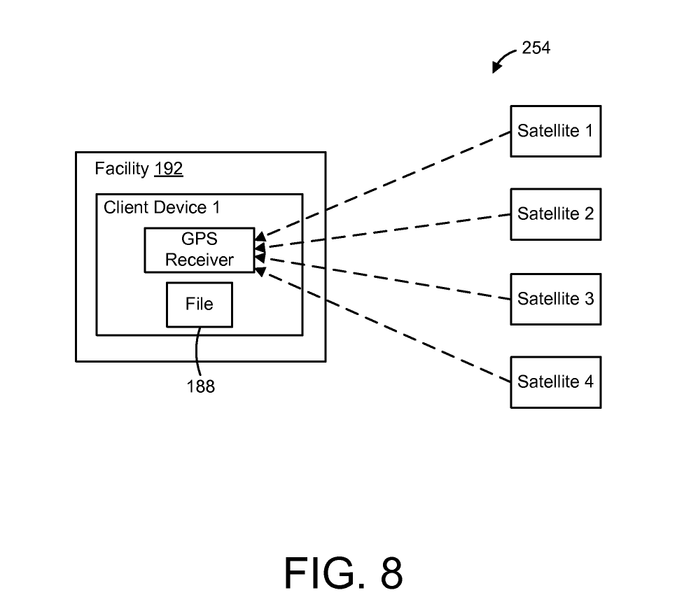

FIG. 8 is a diagram of various implementations of a system 254 that includes a facility 192 of the commercial entity to illustrate a determination of whether the user 1 visited the facility 192. When the user 1 visits the facility 192 with the client device 1, a global positioning system (GPS) receiver within the client device 1 receives signals from two or more of satellites 1 thru 4. Based on distances traveled by the signals from two or more of the satellites and a point of intersection of the signals, a location of the client device 1 is determined by the processor of the client device 1. In response to determining a distance between the location of the client device 1 and a known location of the facility 192 is less than a pre-determined distance, the processor of the client device 1 determines that the client device 1 is within the facility 192. The processor of the client device 1 generates a file 188 that includes information whether the user 1 visited the facility 192. The processor 248 (FIG. 1) receives the file 188 via the network 240 to copy the file 188.

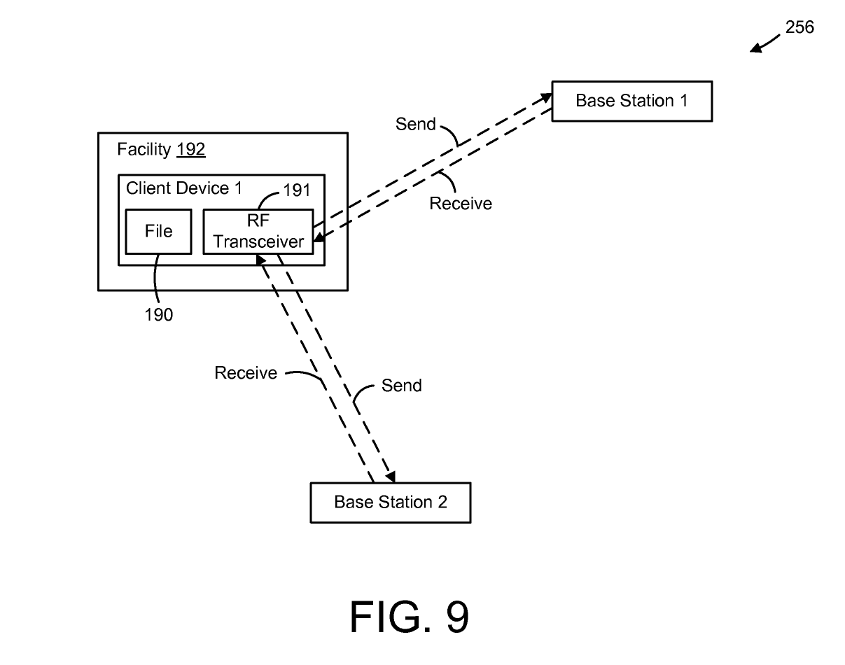

FIG. 9 is a diagram of various implementations of a system 256 that includes the facility 192 to illustrate a determination of whether the user 1 visited the facility 192. When the user 1 visits the facility 192, the user 1 carries the client device 1 to the facility 192. The client device 1 includes a radio frequency (RF) transceiver 191 that transmits RF signals to base stations 1 and 2. The base stations 1 and 2 transmit RF signals to the RF transceiver 191 in response to receiving the RF signals from the RF transceiver 191. The processor of the client device 1 determines whether the client device 1 is located closer to the base station 1 compared to the base station 2 or vice versa and a location of the client device 1 based on strengths of the RF signals received from the base stations 1 and 2. In response to determining a distance between the location of the client device 1 and a known location of the facility 192 is less than the pre-determined distance, the processor of the client device 1 determines that the client device 1 is within the facility 192. The processor of the client device 1 generates a file 190 that includes information regarding whether the user 1 visited the facility 192. The processor 248 (FIG. 1) receives the file 190 via the network 240 to copy the file 190.

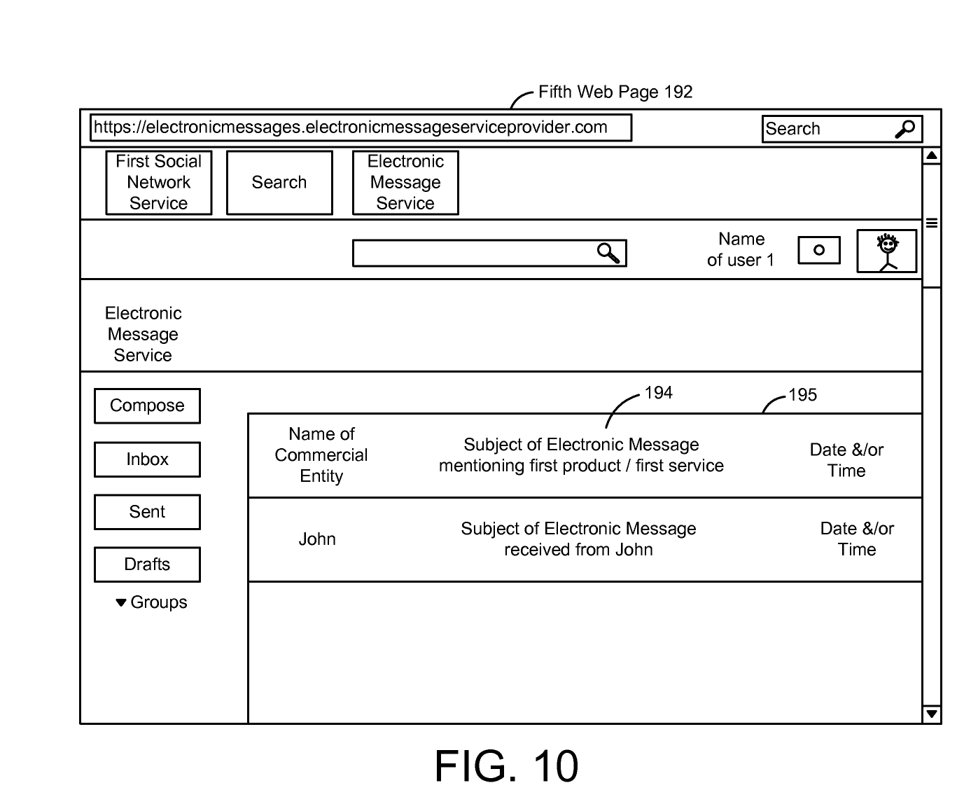

FIG. 10 is a diagram of various implementations of a fifth web page 192, which is an example of the fifth web page 130 (FIG. 3). The fifth web page 192 includes an electronic message 194 that includes a subject. The electronic message 194 is received by the user 1 from the commercial entity. In several implementations, the electronic message 194 is communicated between the user 1 and one or more of the other users 2 thru N. The subject of the electronic message 194 mentions the first product/service to express an opinion of the user 1 regarding the first product/service.

The user 1 receives access to the body of the electronic message 194 when the user 1 selects a field 195 that includes the subject of the electronic message 194. In several implementations, the body and/or the subject of the electronic message 194 mentions the first product/service to express an opinion of the user 1 regarding the first product/service. The processor 248 crawls the fifth web page 192 to copy the subject of the electronic message 194 and/or crawls another web page that displays the body of the electronic message 195 to determine an opinion of the user 1 regarding the drink.

In several implementations, any web page, other than that illustrated in FIGS. 3-7 and 10 is crawled by the processor 248 to obtain data regarding an opinion of the user 1 regarding the first product/service. For example, a web page that includes reviews of the first product/service by the users 1 thru N−1 is crawled by the processor 248 to determine opinions of the users 1 thru N−1 regarding the first product/service.

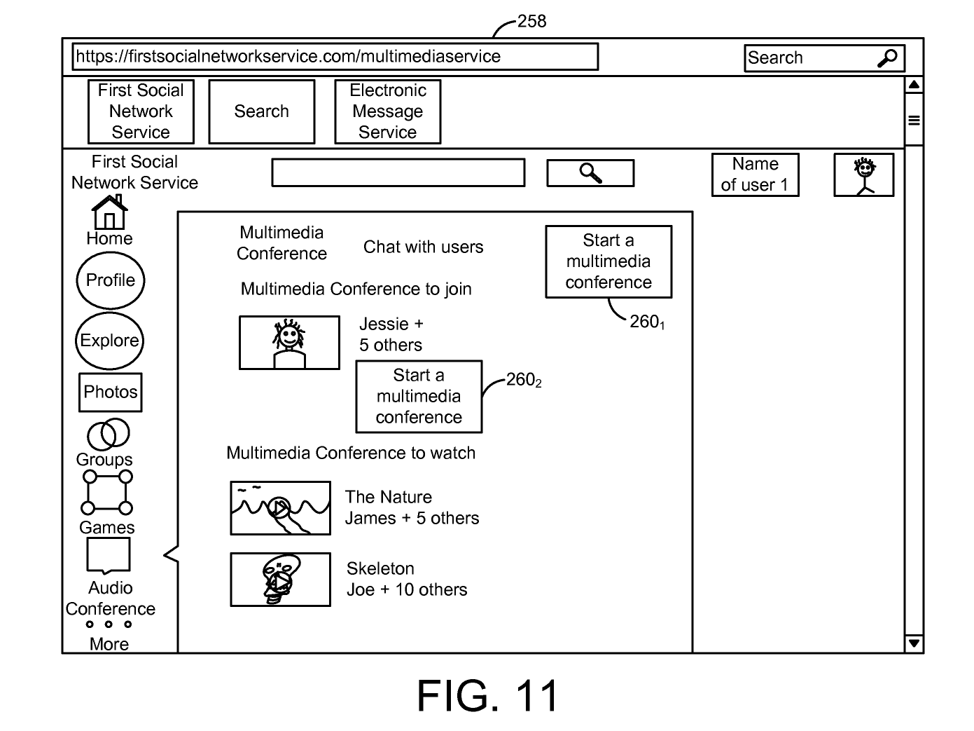

FIG. 11 is a diagram of various implementations of a web page 258 that is displayed when the user 1 receives access to a social network service provided by the first social network 110 (FIG. 1). For example, the web page 258 is displayed when the user 1 logs into the first user account 134 (FIG. 3). When the user 1 selects a button 260₁ or 260₂ on the web page 258, the server 248 (FIG. 1) allows the user 1 to engage in a multimedia chat, e.g., a video conference or a voice chat, with social network friends of the user 1 and/or one or more of the other users 2 thru N. For example, the user 1 uses the client device 1 to engage in a multimedia chat with another user 2 who uses the client device 2 (FIG. 1).

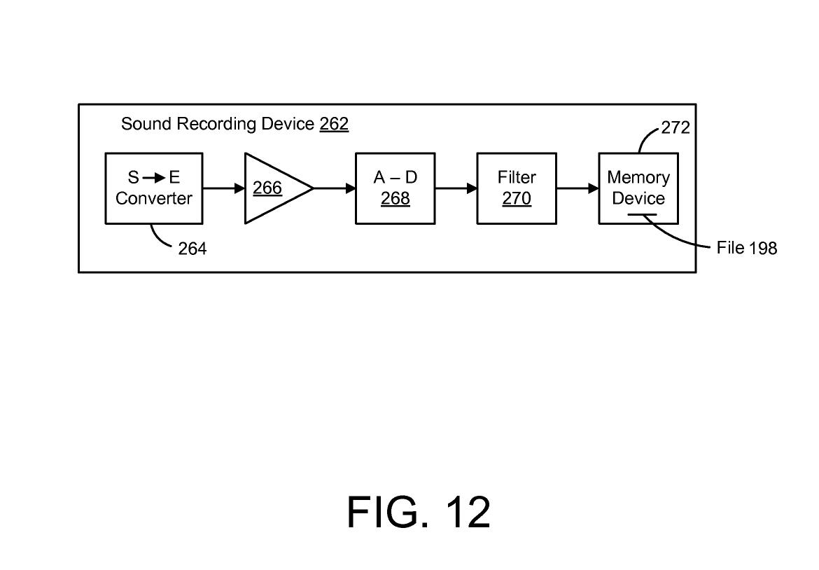

FIG. 12 is a block diagram of various implementations of a sound recording device 262 that records audio data during a multimedia chat of the user 1 with one or more of the other users 2 thru N. In several implementations in which the server 242 provides a multimedia chat service, the sound recording 262 is included within the server 242 (FIG. 1).

In various implementations, the sound recording device 262 is included within a client device. During occurrence of a multimedia chat, the processor 248 (FIG. 1) instructs the sound recording device 262 to record the chat. When the sound recording device 262 records, a sound energy-to-electrical energy converter 264 converts acoustic signals within a sound produced by a user into electrical signals. An amplifier 266 amplifies the electrical signals to generate amplified electrical signals. An analog-to-digital (A-D) converter 268 converts the amplified electrical signals from an analog form to a digital form. A filter 270 filters one or more frequencies of the digital form of the digital signal. The filtered digital signals are stored in the form of a file 198 within a memory device 272.

When the memory device 272 is located within a client device that is operated by a user, the processor 248 copies the file 198 via the network 240 (FIG. 1) to determine whether the user expressed an opinion regarding the first product/service during a multimedia chat. When the memory device 272 is located within the server 242, there is no need for the server 272 to copy the file 198. In several implementations, the memory device 272 is an example of the memory device 250 (FIG. 1) of the server 242.

It should be noted that although the FIGS. 3-12 are described with respect to the user 1 and his/her user accounts, in several implementations, the FIGS. 3-12 and corresponding description apply to the remaining users 2 thru N−1 and their corresponding user accounts.

It should further be noted that although the FIGS. 3-12 are described with respect to the opinions of the user 1 regarding the first product/service, in several implementations, the FIGS. 3-12 and corresponding description apply to opinions of the user 1 regarding the commercial entity.

In various implementations, the processor 248 (FIG. 1) crawls the first web page 122, the second web page 124, the third web page 126, the fourth web page 128, the fifth web page 130 (FIG. 3), another other web page that is accessed by the user 1 after logging into a user account, collects data regarding a location of the client device 1, collects data regarding a multimedia conference between the user 1 and other users 2 thru N, or performs a combination thereof, to collect data regarding activity of the user 1 with respect to the first product/service.

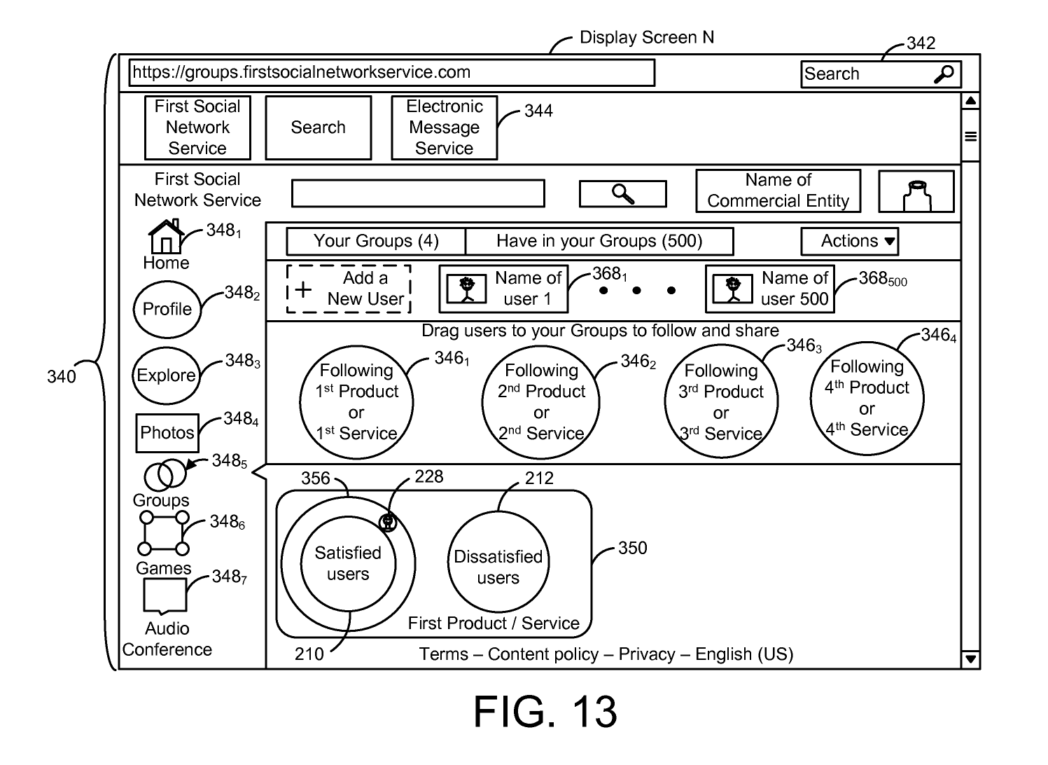

FIG. 13 is a diagram of various implementations of a web page 340 that is displayed on a display screen N of the client device N (FIG. 1) when the user N visits a social group web page of the first social network 110. The user N is provided access to the social network account 106 (FIG. 1) when the user information regarding the user N is authenticated by a server. When the social network account 106 that is part of the first social network 110 (FIG. 1) is accessed by the client device N from the server 242 (FIG. 1), the GPU of the client device N displays the web page 340 on the display screen N. As shown, the web page 340 includes a search field 342 in which the user N can provide via the input device of the client device N a search term to search the first social network 110.

The web page 340 includes a button that allows the user N to switch between various services, e.g., an electronic messaging service, a maps service, a chat service, a finance service, a social network service, a search service to search the World Wide Web, a shopping service, a multimedia conferencing service, a multimedia storage service, etc. For example, the user N can switch to an electronic messaging service when the user N selects an electronic messaging service button 344 on the web page 340. An example of an electronic messaging service is an email service.

Moreover, the web page 340 includes circular shapes 346 that are associated with users who are assigned to social groups of the first social network 110. For example, the circular shape 346₁ includes a number of the users 1 and 2 of a social group that follows the first product/service. As another example, the circular shape 346₂ includes an identity of the users 1, 3, and 4 of a social group that follows a second product/service that is offered by the commercial entity. In various implementations, the second product/service is offered by an organization other than the commercial entity.

In several implementations, when the user N hovers a cursor using the input device of the client device N over one of the circular shapes 346, the circular shape expands to display identities of users that follow a product/service that is linked with the circular shape.

The web page 340 includes multimedia 368₁ thru 368₅₀₀ of users 1 thru 500 that follow products/services offered by the commercial entity. For example, the multimedia 3681 identifies the user 1 and the multimedia 368₅₀₀ identifies the user 500.

The web page 340 further includes multimedia 348. The multimedia 348 is selected by the user N to switch from one web page to another within the first social network 110. For example, when the multimedia 348₁ is selected by the user N via the input device of the client device N, a web page that allows the user N to post, comment and share multimedia is displayed on the display screen N. Moreover, in this example, the web page includes posts, comments, and multimedia that is shared by other users, e.g., users 1 thru N−1, with the user N.

The web page 340 includes a shape 350 that further includes a circular shape 210 and another circular shape 212. The circular shape 210 represents a positive sentiment, e.g., satisfied, of a social group of one or more users of the first social network 110 towards the first product/service. The circular shape 212 represents a negative sentiment, e.g., dissatisfied, of a social group of one or more users of the first social network 110 towards the first product/service. The circular shape 210 includes a number of users, e.g., the user 1, that are satisfied with the first product/service. Similarly, the circular shape 212 includes a number of users that are dissatisfied with the first product/service.

In various implementations, when the user N hovers a cursor via the input device of the client device N over the circular shape 210, the circular shape 210 expands and identities of users that express satisfaction towards the first product/service are displayed within an outer region of an expanded circle 356. For example, an image 228 of the user 1 is displayed when the user N hovers a cursor over the circular shape 210. In several implementations, instead of the image 228, any other multimedia that identifies the user 1 is displayed within the expanded circle 356 when the user N hovers a cursor over the circular shape 210. In a number of implementations, multimedia that identifies the user 1 is displayed within the expanded circle 356 when the user N selects the circular shape 210 instead of hovering a cursor over the circular shape 210. In a number of implementations, the GPU of the client device N obtains the first sentiment group data 116 (FIG. 1) from the server 242 via the network 240 (FIG. 1) and applies the rendering program to the first sentiment group data 116 to display the circular shape 210 and/or the expanded circle 356 within the shape 350.

In several implementations, a multimedia that identifies the user 1 is displayed within the circular shape 210 regardless of whether the user N uses the input device of the client device N to select or hover a cursor over the circular shape 210. In various implementations, a multimedia that identifies the user 1 is displayed within the circular shape 210 when the user N uses the input device of the client device N to select or hover a cursor over the circular shape 210. In these implementations, the circular shape 210 avoids expanding into the expanded circle 356. It should be noted that the implementations that apply to the circular shape 210 and the expanded circle 356 also apply to the circular shape 212 and an expanded circle that is created based on the circular shape 212. In a number of implementations, any number of shapes is included within the shape 350 to represent sentiments of social groups of one or more users.

The display of an identity of the user 1 within the circular shape 210 or within the expanded circle 356 are examples of displaying a representation of the user 1 with respect to a representation of the first sentiment group data 116. The first sentiment group data 116 represents a first sentiment of a social group of one or more users. In several implementations, a display of an identity of the user 1 is represented with respect to a representation of the first sentiment group data 116 when the identity is displayed adjacent to and outside the circular shape 210 or when the identity is displayed adjacent to and outside the expanded circle 356.

In various implementations, the circular shapes 210 and 212 represent discrete sentiments of one or more users. As an example, there exists a sentiment that is generated from an opinion that lies between a like opinion and a somewhat like opinion. As another example, there exists a sentiment that is generated from an opinion that lies between a somewhat positive opinion and a more likely than not positive opinion.

It should be noted that although a number of circular shapes are shown on the web page 340, in various implementations, any other number of circular shapes are shown on the web page 340. In these implementations, the other circular shapes represent sentiments other than a positive sentiment and a negative sentiment. For example, the other shapes represent a somewhat positive sentiment of one or more users towards the first product/service and a somewhat negative sentiment of one or more users towards the first product/service. In several implementations, a different shape than that shown in FIG. 13 is displayed on the web page 340. For example, instead of the circular shapes 346, 210, 212, and the expanded circle 356, a polygonal shape or an oval shape is displayed. As another example, instead of the shape 350 linked with the first product/service, any other shape, e.g., a polygonal, a circular, an oval shape, etc., is displayed on the web page 340.

In various implementations, the arrangement of graphical objects, e.g., the circular shapes 346, the search field 342, the shape 350, the circular shapes 210 and 212, the multimedia 348, and the multimedia 368, within the web page 340 is different than that shown in FIG. 13. For example, the shape 350 is displayed at the top of the web page 340 and the multimedia 368 is displayed at the bottom of the web page 340. In several implementations, the web page 340 excludes one or more of graphical objects, e.g., the multimedia 368, the circular shapes 346, and the multimedia 348. In a number of implementations, the shape 350, the circular shape 210, 212, and the expanded circle 356 are displayed on a different web page than the web page 340.

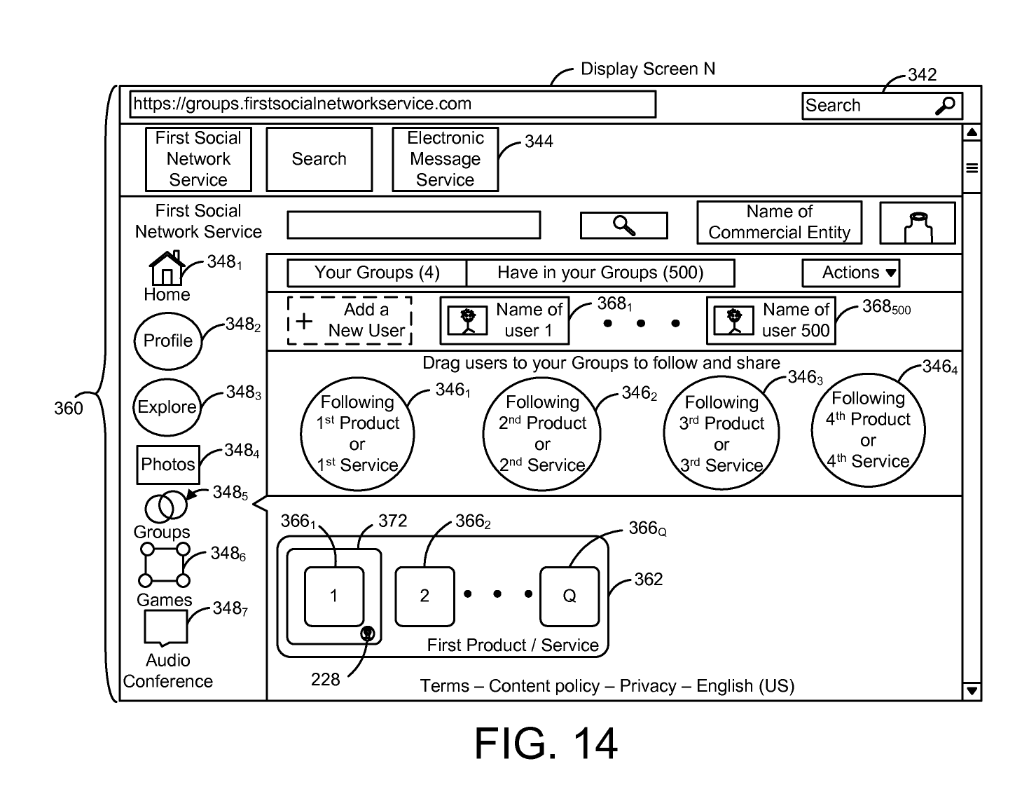

FIG. 14 is a diagram of various implementations of a web page 360 that is displayed on the display screen N. The web page 360 is accessed in a manner similar to that of accessing the web page 340 (FIG. 13). For example, the user N is provided access to the social network account 106 when the user information regarding the user N is authenticated by a server. When the social network account 106 (FIG. 1) is accessed by the client device N from the server 242 (FIG. 1), the GPU of the client device displays the web page 360 on the display screen N.

The web page 360 includes a shape 362 that includes polygonal shapes 366₁ thru 366_{Q}, where Q is an integer greater than zero. The polygonal shapes 366 represent social groups and each social group represents a sentiment of one or more users towards the first product/service. For example, the polygonal shape 366₂ represents a somewhat positive sentiment of one or more users 1 thru N towards the first product/service. As another example, the polygonal shape 366₁ represents a positive sentiment of a social group that includes one or more users 1 thru N. As yet another example, the polygonal shape 366_{Q} represents a negative sentiment of a social group that includes one or more users. An identity of the user 1 is assigned by the processor 248 (FIG. 1) to the polygonal shape 366₁ when the user 1 likes the first product/service.

The web page 360 is generated in a manner similar to generation of the web page 340 (FIG. 13) except that sentiments of social groups are expressed in a continuous form on the web page 360 rather than in a discrete form. For example, all types of opinions of all the users 1 thru N are used to generate sentiments from 1 to Q within the polygonal shapes 366.

It should be noted that although integers 1 thru Q are used to represent sentiments of social groups, in various implementations, alphanumeric characters, e.g., Roman numerals, alphabets etc., are used to represent the sentiments.

In various implementations, when the user N hovers a cursor via the input device of the client device N over the polygonal shape 366₁, the polygonal shape 366₁ expands and identities of users that express likeness towards the first product/service are displayed within an outer region of an expanded polygonal shape 372. For example, the image 228 of the user 1 is displayed when the user N hovers a cursor over the polygonal shape 366₁. In several implementations, instead of the image 228, any other multimedia that identifies the user 1 is displayed within the expanded polygonal shape 372 when the user N hovers a cursor over the polygonal shape 366₁. In a number of implementations, multimedia that identifies the user 1 is displayed within the expanded polygonal shape 372 when the user N selects the polygonal shape 366₁. In a number of implementations, the GPU of the client device N obtains the first sentiment group data 116 (FIG. 1) from the server 242 via the network 240 (FIG. 1) and applies the rendering program to the first sentiment group data 116 to display the polygonal shape 366₁ and/or the expanded polygonal shape 372 within the shape 362.

In several implementations, a multimedia that identifies the user 1 is displayed within the polygonal shape 366₁ regardless of whether the user N uses the input device of the client device N to select or hover a cursor over the polygonal shape 366₁. In various implementations, a multimedia that identifies the user 1 is displayed within the polygonal shape 366₁ when the user N uses the input device of the client device N to select or hover a cursor over the polygonal shape 366₁. In these implementations, the polygonal shape 366₁ avoids expanding into the expanded polygonal shape 372. It should be noted that the implementations that apply to the polygonal shape 366₁ and the expanded polygonal shape 372 also apply to the polygonal shape 366₂ and an expanded polygon that is created based on the polygonal shape 366₂. In a number of implementations, any number of shapes is included within the shape 362 to represent sentiments of social groups of one or more users.

In a number of implementations, instead of the polygonal shapes displayed on the web page 360 to represents sentiments of social groups, another shape, e.g., circular shape, oval shape, etc. is used.

It should be noted that although FIGS. 13 and 14 are described with respect to sentiments of one or more users towards the first product/service, in various implementations, sentiments of one or more users towards the commercial entity may be shown in a form similar to the shapes shown in the FIGS. 13 and 14. For example, the circular shape 210 (FIG. 13) represents a positive sentiment of a social group towards the commercial entity. As another example, the shape 366₁ represents a more positive sentiment of a social group towards the commercial entity. The more positive sentiment is more positive than a positive sentiment.

Moreover, in several implementations, sentiments of social groups for different products/services are displayed on different web pages. For example, instead of representing sentiments of social groups towards the second product/service and the first product/service on a web page, e.g., the web page 340, the sentiments towards the second product/service are included within another web page. The other web page is accessed in a variety of ways, e.g., when the user N selects a tab representing the second product/service displayed on the web page that represents sentiments towards the first product/service via the input device of the client device N, when the user N selects multimedia representing the second product/service displayed on the web page that represents sentiments towards the first product/service, etc.

Additionally, in several implementations, instead of using the same shape to represent different sentiments of social groups, different shapes are used to represent the different sentiments. For example, an oval shape is used to represent a social group with positive sentiment and a triangle is used to represent a social group with a negative sentiment.

In various implementations, instead of using shapes to represent sentiments of social groups, other multimedia, e.g., text, videos, etc., is used to represent the sentiments.

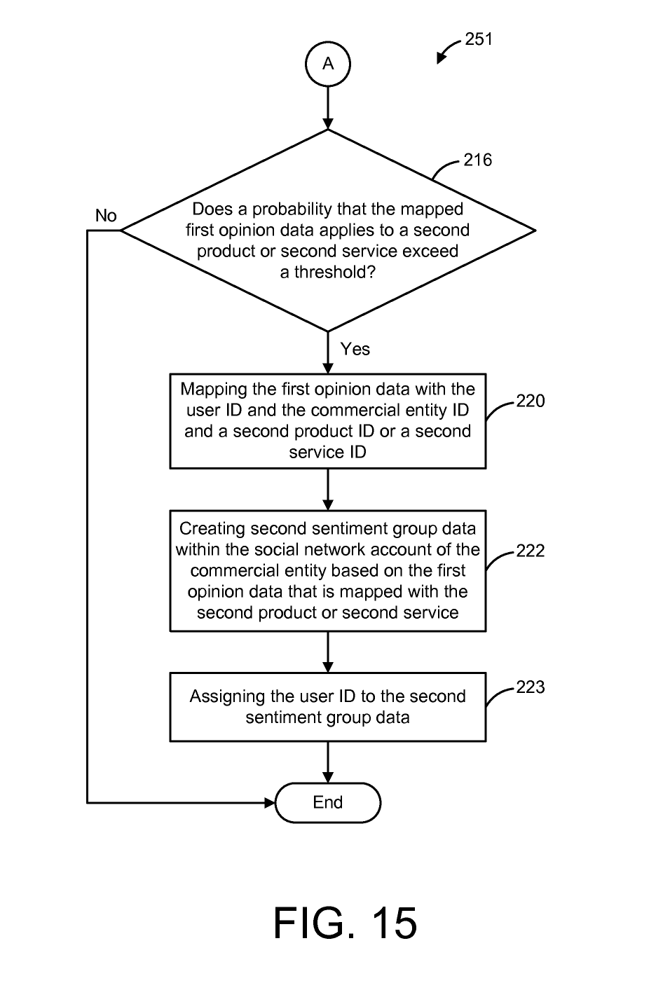

FIG. 15 is a flowchart of various implementations of a method 251 for assigning an identity of a user to a sentiment towards the second product/service based on an opinion of the user towards the first product/service and similarity between the first product/service with the second product/service. The method 251 is executed by one or more processors, e.g., processor 248 (FIG. 1), of one or more servers.

In several implementations, the method 100 (FIG. 2) ends are the operation 120 (FIG. 2). In various implementations, the method 251 follows the operation 120.

In an operation 216, it is determined whether a probability that the first opinion data 118 (FIG. 1) applies to the second product/service exceeds a threshold. To determine whether the probability exceeds the threshold, it is determined whether the first product/service is related to the second product/service. For example, it is determined whether the first product/service is similar to the second product/service. To illustrate further, it is determined whether the first product/service has similar features, similar functionality, similar shape, or a combination thereof, as that of the second product/service. Examples of features include taste, retention of power, etc. Examples of functionality include oscillating, improving vision of eyes, curing cancer, reducing stress, reducing physical pain, reducing mental pain, computing, storing digital data, organizing, data mining, etc. As another illustration, it is determined whether the second product/service falls under the same category as that of the first product/service. Examples of a category include drinks, software, cleaning, washing, legal, finance, cars, vehicles, batteries, pens, stationery, juice, food, paper cups, etc.

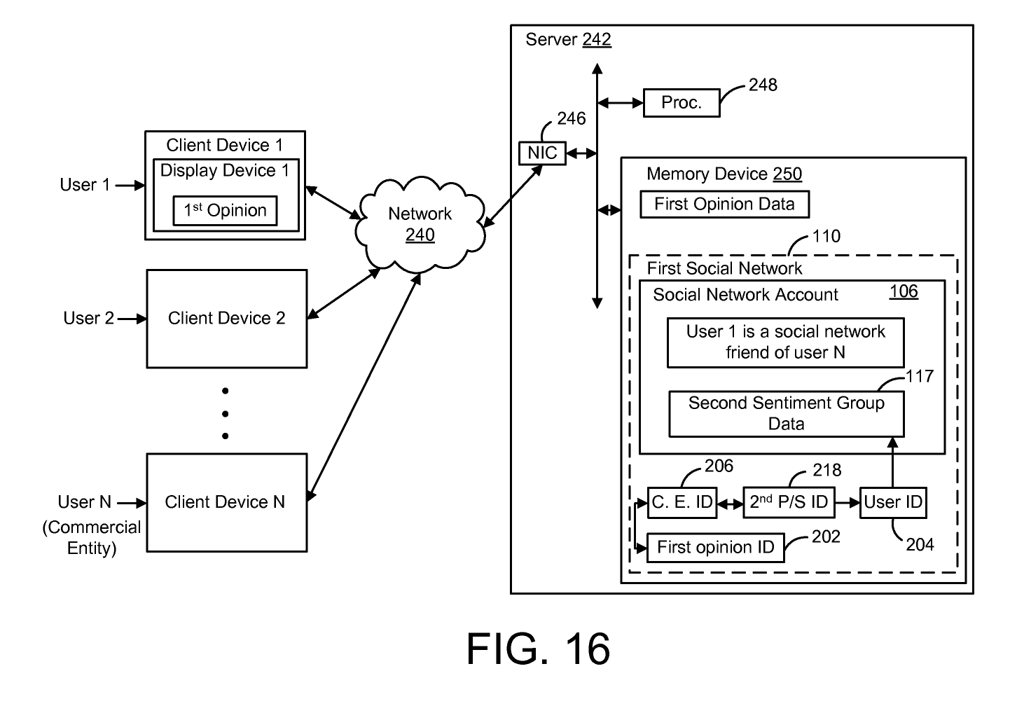

The threshold is stored within the memory device 250 (FIG. 1). In response to determining that the probability is less than or equal to the threshold, the method 251 ends. The second product/service is assigned a second product/service ID 218 by the processor 248. The second product/service ID 218 is illustrated in FIG. 16.

On the other hand, in response to determining that the probability exceeds the threshold, in an operation 220, the first opinion data 118 is mapped with the user ID 204, the commercial entity ID 206, and the second product/service ID 218. For example, the processor 248 creates an association, e.g., a relationship or a link, between the first opinion ID 202, the user ID 204, the commercial entity ID 206, and the second product/service ID 218.

In an operation 222, second sentiment group data 117 (FIG. 16) is created within the social network account 106 (FIG. 1) of the commercial entity based on the first opinion data 118 that is mapped with the second product/service. For example, the second sentiment group data 117 is similar to the first sentiment group data 116 in that the first sentiment group data 116 and the second sentiment group data 117 are generated from the first opinion 104. As another example, the first sentiment group data 116 is copied and modified to apply the first sentiment group 116 to the second product/service. As another example, when the first opinion 104 (FIG. 1) of the user 1 is a positive opinion towards the first product/service, an opinion of the user 1 towards the second product/service is determined to be positive. As yet another example, when the first opinion 104 of the user 1 is a negative opinion towards the first product/service, an opinion of the user 1 towards the second product/service is determined to be negative. The processor 248 assigns a sentiment group ID to the second sentiment group data 117.

In an operation 223, the user ID 204 is assigned to the second sentiment group data 117. For example, the processor 248 associates the user ID 204 with the sentiment group ID of the second sentiment group data 117. The method 251 ends after the operation 223.

In various implementations, the first sentiment group data 116 is dynamically associated with the user ID 204 and the second product/service. For example, when the processor 248 determines that the second product/service ID 218 is generated and that the first product/service is related to the second product/service, the processor 248 generates a copy of the first sentiment group data 116 and modifies the copy to apply the first sentiment group data 116 to the second product/service, maps the modified copy with the second product/service ID 218 to generate the second sentiment group data 117, and stores the second sentiment group data 117 within the memory device 250.

The second sentiment group data 117 is sent via the network 240 to the client device N. When the user N logs into the social network account 106 (FIG. 1), the GPU of the client device N applies the rendering program to the second sentiment group data 117 to display another sentiment of a social group towards the second product/service and displays an identity of the user 1 with respect to the other sentiment. The other sentiment is similar to the first sentiment except that the other sentiment is expressed towards the second product/service and the first sentiment is expressed towards the first product/service. For example, when the first sentiment is positive, the other sentiment is positive.

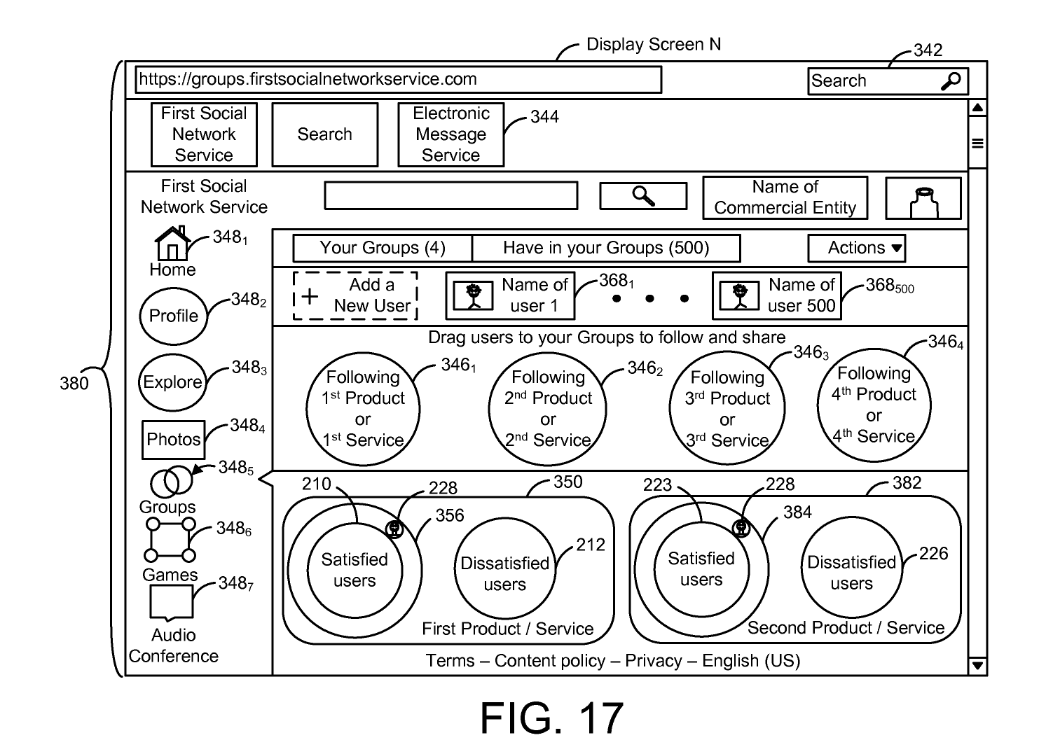

FIG. 17 is a diagram of various implementations of a web page 380 that is similar to the web page 340 (FIG. 13) except that the web page 380 includes a social group that represents a sentiment of one or more users towards the second product/service. The web page 380 is accessed by the user N in a manner similar to that of accessing the web page 340 (FIG. 13). The web page 280 is displayed on the display screen N.

The web page 360 includes a shape 382 that further includes a circular shape 223 and another circular shape 226. The circular shape 223 represents a positive sentiment, e.g., satisfied, of a social group of one or more users of the first social network 110 towards the second product/service. As an example, the GPU of the client device N obtains the second sentiment group data 117 (FIG. 16) from the server 242 via the network 240 (FIG. 1) and applies the rendering program to the second sentiment group data 117 to display the circular shape 223 within the shape 382. The circular shape 226 represents a negative sentiment, e.g., dissatisfied, of a social group of one or more users of the first social network 110 towards the second product/service. The circular shape 223 includes a number of users, e.g., the user 1, that are satisfied with the second product/service. Similarly, the circular shape 226 includes a number of users that are dissatisfied with the second product/service.

In various implementations, when the user N hovers a cursor via the input device of the client device N over the circular shape 223, the circular shape 223 expands and identities of users that express satisfaction towards the second product/service are displayed within an outer region of an expanded circle 384. For example, the image 228 of the user 1 is displayed when the user N hovers a cursor over the circular shape 223. In several implementations, instead of the image 228, any other multimedia that identifies the user 1 is displayed within the expanded circle 356 when the user N hovers a cursor over the circular shape 223.

It should be noted that the various implementations that apply to the circular shape 210 also apply the circular shape 223. For example, although a number of circular shapes are shown on the web page 380, in various implementations, any other number of circular shapes is shown on the web page 380. As another example, a different shape than that shown in FIG. 17 is displayed on the web page 380. To further illustrate, instead of the circular shape 223 and a shape of the expanded circle 384, a polygonal shape or an oval shape is displayed.

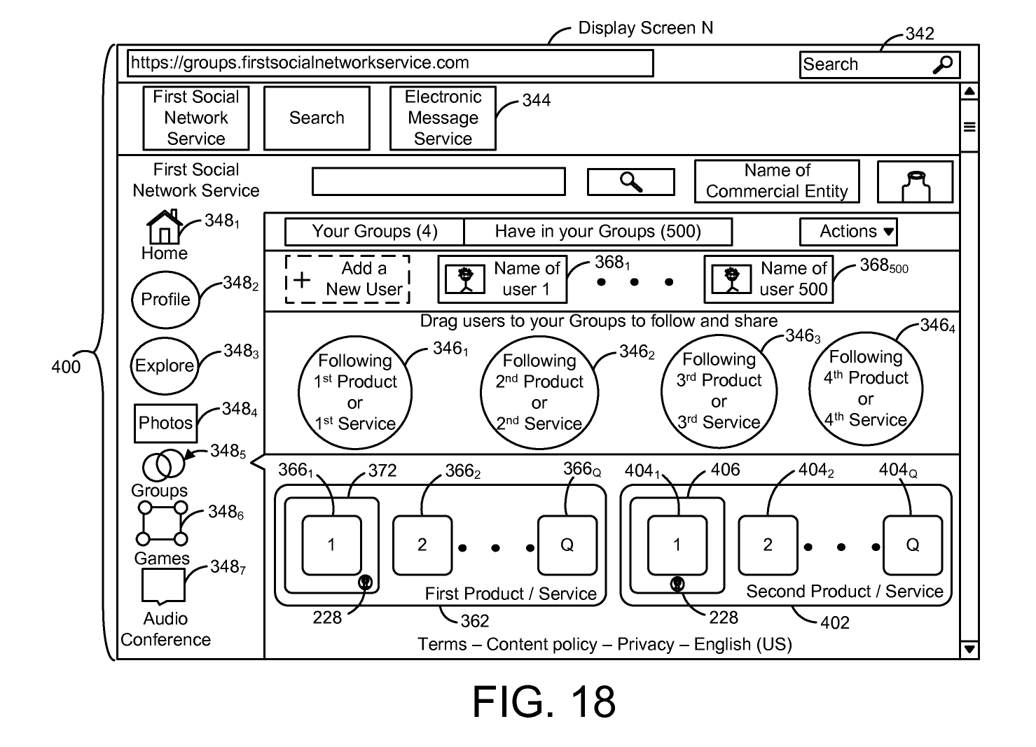

FIG. 18 is a diagram of various implementations of a web page 400 that is displayed on the display screen N. The web page 400 is accessed in a manner similar to that of accessing the web page 360 (FIG. 14). Also, the web page 400 is similar to the web page 360 except that the web page 400 includes a shape 402.

The shape 402 that includes polygonal shapes 404₁ thru 404_{Q}. The polygonal shapes 404 represent social groups and each social group represents a sentiment of one or more users towards the second product/service. For example, the polygonal shape 404₂ represents a somewhat positive sentiment of one or more users 1 thru N towards the second product/service. As another example, the polygonal shape 404₁ represents a positive sentiment of a social group that includes one or more users 1 thru N. As yet another example, the polygonal shape 404_{Q} represents a negative sentiment of a social group that includes one or more users. As another example, the GPU of the client device N obtains the second sentiment group data 117 (FIG. 16) from the server 242 via the network 240 (FIG. 1) and applies the rendering program to the second sentiment group data 117 to display the polygonal shape 4041 within the shape 402. An identity of the user 1 is assigned by the processor 248 (FIG. 1) to the polygonal shape 404₁ when the user 1 somewhat likes the first product/service and independent of whether the user 1 likes or dislikes the second product/service.

In various implementations, when the user N hovers a cursor via the input device of the client device N over the polygonal shape 404₁, the polygonal shape 404₁ expands and identities of users that express likeness towards the first product/service are displayed within an outer region of an expanded polygonal shape 406. For example, the image 228 of the user 1 is displayed when the user N hovers a cursor over the polygonal shape 404₁. In several implementations, instead of the image 228, any other multimedia that identifies the user 1 is displayed within the expanded polygonal shape 406 when the user N hovers a cursor over the polygonal shape 404₁.

Moreover, the same implementations that apply to the shape 362 (FIG. 14) also apply to the shape 402. For example, multimedia that identifies the user 1 is displayed within the expanded polygonal shape 406 when the user N selects, instead of using a cursor to hover over, the polygonal shape 404₁. As another example, a multimedia that identifies the user 1 is displayed within the polygonal shape 404₁ or the expanded polygonal shape 406 regardless of whether the user N uses the input device of the client device N to select or hover a cursor over the polygonal shape 404₁. As yet another example, instead of the polygonal shapes displayed on the web page 400 to represent sentiments of social groups, another shape, e.g., circular shape, oval shape, etc. is used.

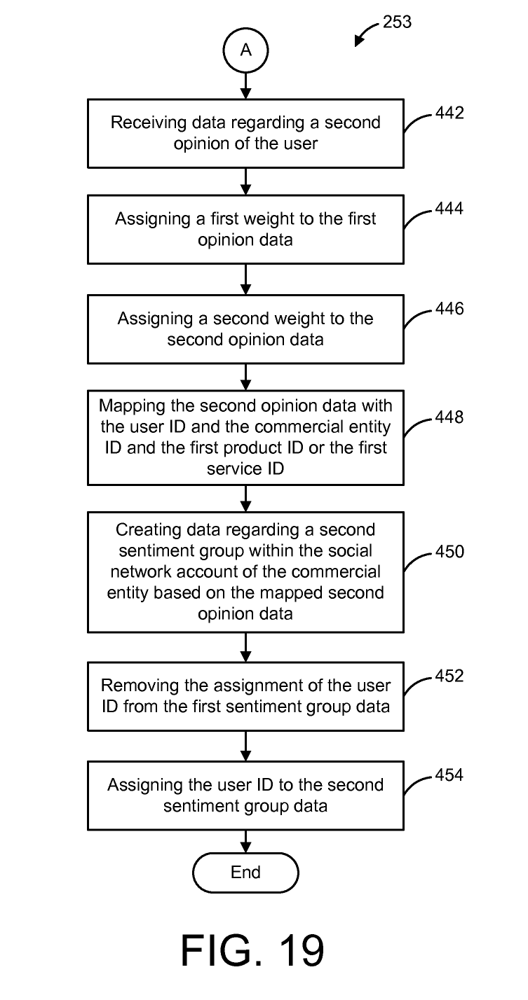

FIG. 19 is a flowchart of various implementations of a method 253 for reassigning a user ID from representing the first sentiment to representing a second sentiment. The method 253 is executed by one or more processors, e.g., the processor 248 (FIG. 1), of one or more servers. In several implementations, the method 253 is performed after the method 100 (FIG. 1) is performed. In various implementations, the method 253 is performed after the method 251 (FIG. 15) is performed. In several implementations, the method 251 is performed after the method 253 is performed.

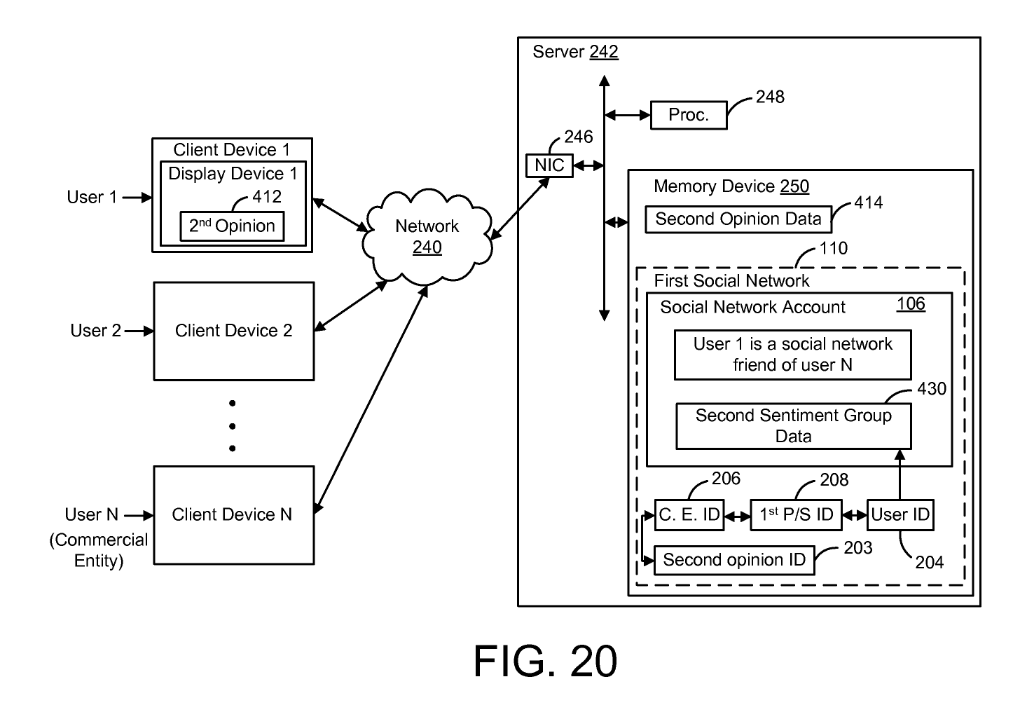

In an operation 442, data 414, which is shown in FIG. 20, regarding a second opinion 412 (FIG. 20) of the user 1 is obtained. The second opinion 412 is an opinion regarding the first product/service and is different from the first opinion 104 (FIG. 1). For example, when the first opinion 104 is liking the first product/service, the second opinion 412 is disliking the first product/service, more like than not disliking the first product/service, more likely than not disliking the first product/service, etc. The second opinion data 414 is obtained by the NIC 246 via the network 240 (FIG. 20) from the NIC of the client device 1. Also, the second opinion 412 is expressed by the user 1 after the first opinion 204 (FIG. 1) is expressed by the user 1. For example, the NIC 246 (FIG. 20) of the server 242 receives the second opinion data 414 (FIG. 20) from the NIC of the client device 1 via the network 240 after the NIC 246 receives the first opinion data 118 (FIG. 1). The second opinion data 414 is assigned a second opinion ID 203 (FIG. 20) by the processor 248.

In an operation 444, a first weight is assigned to the first opinion data 118 (FIG. 1). Examples of a weight include an integer, a fraction, etc. Moreover, in an operation 446, a second weight is assigned to the second opinion data 414. The second weight is greater than the first weight. In various implementations, the second weight is less than or equal to the first weight.

In an operation 448, the second opinion data 414 is mapped with the user ID 204 of the user 1, the commercial entity ID 206, the first product/service ID 208, and the second opinion ID 203. For example, the processor 248 creates an association between the second opinion ID 203, the user ID 204, the commercial entity ID 206, and the first product/service ID 208. The second opinion data 414 is mapped with the user ID 204, the commercial entity ID 206, the first product/service ID 208, and the second opinion ID 203 instead of the first opinion data 118 (FIG. 1) when the second weight is greater than the first weight.

In an operation 450, second sentiment group data 430 (FIG. 20) is created within the social network account 206 based on the mapped second opinion data 414. For example, the second sentiment group data 430 is created within the social network account 106 of the commercial entity based on the second opinion data 414 having the second opinion ID 203 that is mapped with the user ID 204, the commercial entity ID 206, and the first product/service ID 208. As another example, if the second opinion data 414 indicates that the user 1 dislikes the first product/service, the processor 248 generates negative sentiment data as the second sentiment group data 430. The processor 248 assigns a sentiment group ID to the second sentiment group data 430.

In an operation 452, the assignment of the user ID 204 from the first sentiment group data 116 (FIG. 1) is removed. For example, the processor 248 disassociates the user ID 204 with the sentiment group ID of the first sentiment group data 116. As another example, the processor 248 removes the user ID 204 from being in the same row as that of the sentiment group ID of the first sentiment group data 116. As another example, the processor 248 removes the user ID 204 from being in the same row as that of the sentiment group ID of the first sentiment group data 116, the commercial entity ID 206, the first product/service ID 208, and the first opinion ID 202 (FIG. 1).

In an operation 454, the user ID 204 is assigned to the second sentiment group data 430. For example, the processor 248 associates the user ID 204 with the sentiment group ID of the second sentiment group data 430. As another example, the processor 248 maintains, within a table of the memory device 250, the user ID 204 in the same row as that of the sentiment group ID of the second sentiment group data 430. As yet another example, the processor 248 maintains, within a table of the memory device 250, the user ID 204 in the same row as that of the sentiment group ID of the second sentiment group data 430, the commercial entity ID 206, the first product/service ID 208, and the second opinion ID 203. In various implementations, the method 253 ends after the operation 454.

The second sentiment group data 430 is sent via the network 240 to the client device N. When the user N logs into the social network account 106 (FIG. 20), the GPU of the client device N renders the second sentiment group data 430 to display a social group having the second sentiment.

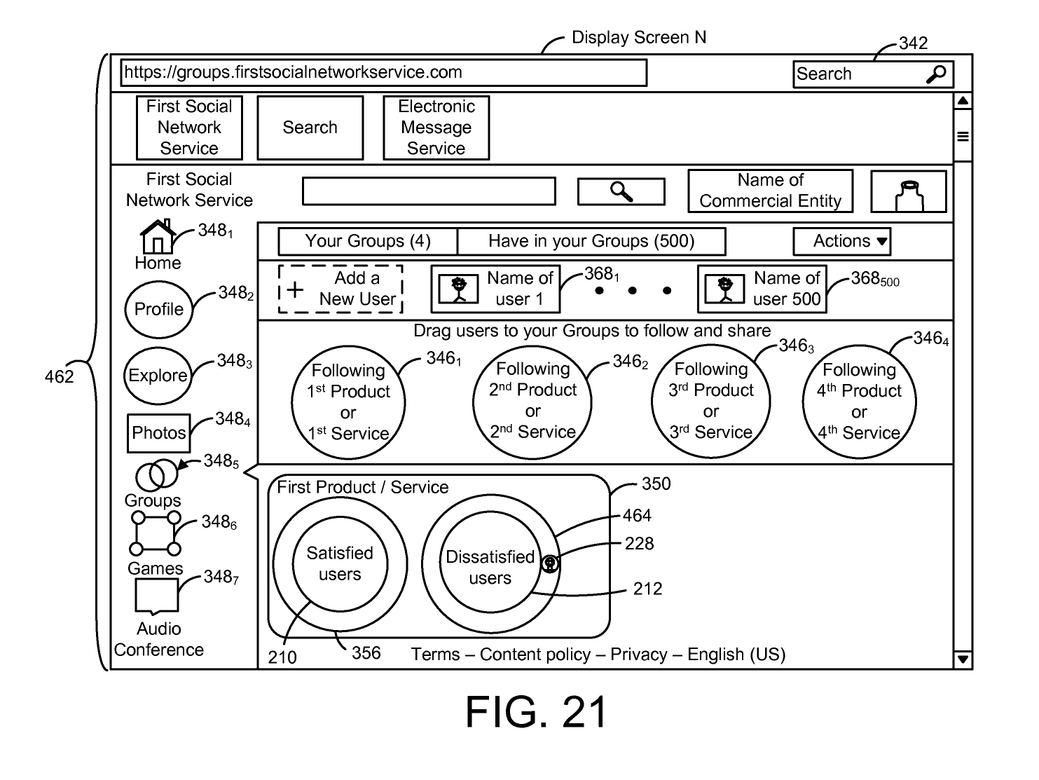

FIG. 21 is a diagram of various implementations of a web page 462 that is displayed on the display screen N when an opinion of the user 1 changes. The web page 462 is similar to the web page 340 (FIG. 13) except that the web page 462 includes a different sentiment of the user 1 compared to that shown on the web page 340.

The user N is provided access to the web page 462 in a manner similar to provision of access to the web page 340. For example, the user N is provided access to the social network account 106 when the user information regarding the user N is authenticated by a server. When the social network account 106 is accessed by the client device N from the server 242 (FIG. 1), the GPU of the client device N displays the web page 462 on the display screen N.

In various implementations, when the user N hovers a cursor via the input device of the client device N over the circular shape 212, the circular shape 212 expands and identities of users that express dissatisfaction towards the first product/service are displayed within an outer region of an expanded circle 464. For example, the image 228 of the user 1 is displayed when the user N hovers a cursor over the circular shape 212. After the change in opinion from the first opinion 118 to the second opinion 412, the image 228 is no longer visible within the expanded circle 356. The circular shape 212 and/or the expanded circle 464 include a social group of one or more users that are dissatisfied with the first product/service. In various implementations, the circular shape 212 and/or the expanded circle 464 are displayed when the GPU of the client device N renders the second sentiment group data 430 (FIG. 20).

The various implementations that apply to the circular shape 210 and the expanded circle 356 (FIG. 13) also apply to the circular shape 212. For example, instead of the image 228, any other multimedia that identifies the user 1 is displayed within the expanded circle 464 when the user N hovers a cursor over the circular shape 212. As another example, multimedia that identifies the user 1 is displayed within the expanded circle 464 when the user N selects the circular shape 212. As yet another example, a multimedia that identifies the user 1 is displayed within the circular shape 212 regardless of whether the user N uses the input device of the client device N to select or hover a cursor over the circular shape 212. As another example, a multimedia that identifies the user 1 is displayed within the circular shape 212 when the user N uses the input device of the client device N to select or hover a cursor over the circular shape 212. In this example, the circular shape 212 avoids expanding into the expanded circle 464.

The display of an identity of the user 1 within the circular shape 212 or within the expanded circle 464 are examples of displaying a representation of the user 1 with respect to a representation of the second sentiment group data 430, which includes information regarding the second sentiment. In several implementations, a display of an identity of the user 1 is represented with respect to a representation of the second sentiment group data 430 when the identity is displayed adjacent to and outside the circular shape 212 or when the identity is displayed adjacent to and outside the expanded circle 464.

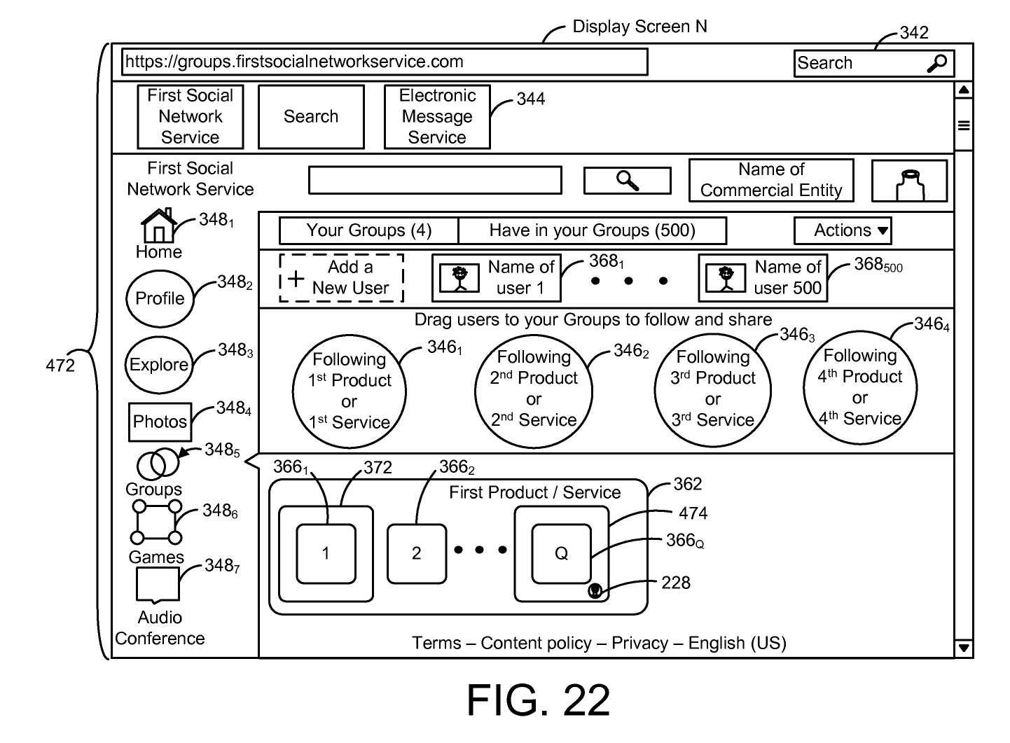

FIG. 22 is a diagram of various implementations of a web page 472 that is displayed on the display screen N. The web page 472 is accessed in a manner similar to that of accessing the web page 360 (FIG. 14).

In various implementations, when the user N hovers a cursor via the input device of the client device N over the polygonal shape 366_{Q}, the polygonal shape 366_{Q} expands and identities of users that express likeness towards the first product/service are displayed within an outer region of an expanded polygonal shape 474. For example, the image 228 of the user 1 is displayed when the user N hovers a cursor over the polygonal shape 366_{Q}. It should be noted that the image 228 is no longer displayed within the expanded polygonal shape 372. This change in display represents a change from the first sentiment to the second sentiment of the user 1. In several implementations, the polygonal shape 366_{Q} and/or the expanded polygonal shape 474 are displayed when the GPU of the client device N renders the second sentiment group data 430 (FIG. 20).

Moreover, the implementations that apply to the polygonal shape 366₁ apply to the polygonal shape 366_{Q} and that apply to the expanded polygonal shape 372 also apply to the expanded polygonal shape 474. For example, instead of the image 228, any other multimedia that identifies the user 1 is displayed within the expanded polygonal shape 474 when the user N hovers a cursor over the polygonal shape 366_{Q}. As another example, multimedia that identifies the user 1 is displayed within the expanded polygonal shape 474 when the user N selects the polygonal shape 366_{Q}. As another example, instead of the polygonal shapes displayed on the web page 472 to represents sentiments of social groups, another shape, e.g., circular shape, oval shape, etc. is used.

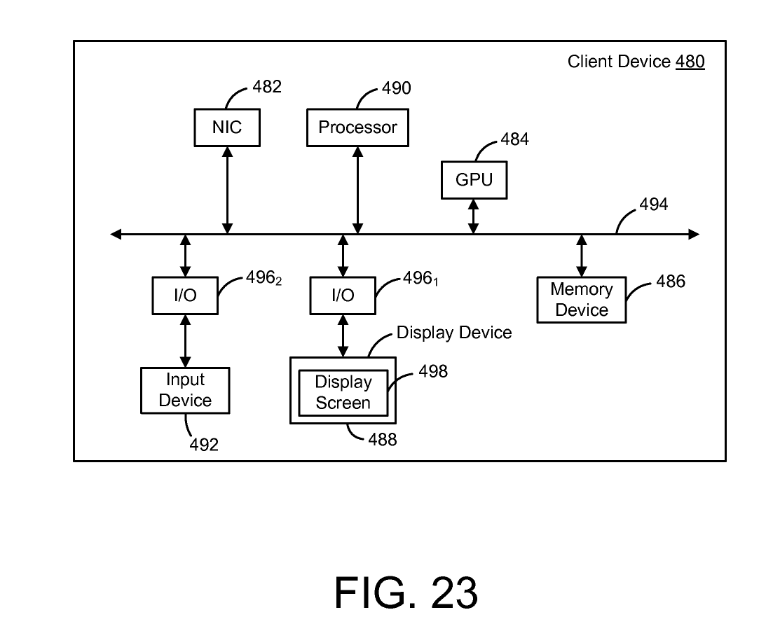

FIG. 23 is a block diagram of various implementations of a client device 480. The client device 480 includes a NIC 482, a GPU 484, a memory device 486, a display device 488, a processor 490, and an input device 492. The client device 480 is an example of any of the client devices 1 thru N (FIG. 1).

Examples of the display device 488 include an LCD device, an LED display device, a CRT display device, and a plasma display device. The display device 488 includes the display screen 498 and is coupled with a bus 494 via an input/output interface (I/O) 496₁. An I/O provides compatibility between the bus 494 and a device that is coupled with the I/O. For example, the I/O 496₁ converts a rate of transfer of data on bus 494 to a rate of transfer of data of display device 488. As another example, an I/O converts a protocol used by one device coupled with the I/O to a protocol that is used by the bus 494 that is coupled with the I/O. The display screen 498 is an example of any of the display screens 1 thru N (FIG. 1).

Examples of an input device include a mouse, a keypad, a keyboard, and a stylus. In various implementations, the input device 492 is integrated within the display screen 498. For example, the input device 492 is a touch screen. The input device 492 is coupled with the bus 494 via an I/O 496₂. The NIC 482 communicates with the server system 242 and/or other servers via the network 240 (FIG. 1).

It should be noted that in various implementations, the client device 480 includes any number of processors, memory devices, input devices, I/Os, display devices, NICs and GPUs. Moreover, in some several implementations, all functions that are performed by the GPU 484 are performed by the processor 490.

Implementations described in the present disclosure may be fabricated as computer-readable code on a non-transitory computer-readable storage medium, which is a storage device or a memory device. The non-transitory computer-readable storage medium holds data which may be read by a computer system. Examples of the non-transitory computer-readable storage medium include network attached storage (NAS), a memory device, a ROM, a RAM, a combination of RAM and ROM, a Compact Disc (CD), a Blu-ray™ disc, a flash memory, a hard disk, and a magnetic tape. The non-transitory computer-readable storage medium may be distributed over a network-coupled computer system so that the computer-readable code is stored and executed in a distributed fashion.

Although the method operations were described in a specific order in the flowcharts of FIGS. 5, 15, and 19, it should be understood that some operations may be performed in a different order, when the order of the operations do not affect the expected results. In addition, other operations may be included in the methods presented, and the operations may be performed by different entities in a distributed fashion, as long as the processing of the operations is performed in a desired way.

In addition, at least one operation of some methods performs physical manipulation of physical quantities, and some of the operations described herein are useful machine operations. Implementations presented herein recite a device or apparatus. The apparatus is specially constructed for a purpose. The apparatus includes a processor capable of executing the program instructions of the computer programs presented herein.

Although the foregoing implementations have been described with a certain level of detail for purposes of clarity, it is noted that certain changes and modifications may be practiced within the scope of the appended claims. Accordingly, the provided implementations are to be considered illustrative and not restrictive, not limited by the details presented herein, and may be modified within the scope and equivalents of the appended claims.

1. A method comprising:
receiving data regarding a first opinion of one of a plurality of users, the first opinion concerning a first product or first service offered by the commercial entity, the user designated as a social network friend of the commercial entity within a social network account of the commercial entity, the social network account maintained in a first social network, the user having a user identity (ID) within the first social network, the commercial entity having a commercial entity ID within the first social network, the first product having a first product ID within the first social network, the first service having a first service ID within the first social network;
mapping the first opinion data with the user ID and the commercial entity ID and the first product ID or the first service ID;
creating data regarding a first sentiment group within the social network account of the commercial entity based on the mapped first opinion data, the first sentiment group providing an indication of a first sentiment of the user regarding the first product or first service; and
assigning the user ID to the first sentiment group data.

2. The method of claim 1, wherein said receiving data regarding the first opinion is performed by crawling one or more web pages, the one or more web pages displayed at one or more client devices.

3. The method of claim 2, wherein the crawling one or more web pages comprises:
crawling a web page for structured data communicated between the user and other users;
crawling a web page for unstructured data communicated between the user and the other users; or
a combination thereof.

4. The method of claim 2, wherein the crawling of one or more web pages comprises crawling a web page to obtain data regarding a like or a dislike by the user of the first product or first service.

5. The method of claim 1, further comprising assigning an opinion ID to the first opinion data, wherein mapping the first opinion data with the user ID and the commercial entity ID and the first product ID or the first service ID comprises associating the user ID and the commercial entity ID and the first product ID or the first service ID with the opinion ID.

6. The method of claim 1, wherein creating the first sentiment group data comprises generating data regarding whether the one or more of the users are dissatisfied with the first product or first service or data regarding whether the one or more users are satisfied with the first product or first service.

7. The method of claim 1, wherein creating the first sentiment group data comprises generating data regarding one of discrete representations of sentiments of the one or more users.

8. The method of claim 1, wherein creating the first sentiment group data comprises generating alphanumeric data regarding one of continuous representations of sentiments of the one or more users.

9. The method of claim 1, further comprising dynamically associating the first sentiment group data and the user ID with a second product or second service offered by the commercial entity, the second product related to the first product, the second service related to the first service.

10. The method of claim 1, further comprising:
determining a probability that the mapped first opinion data applies to a second product or second service, the second product assigned a second product ID, the second service assigned a second service ID, the second product offered by the commercial entity, the second service offered by the commercial entity;
mapping the first opinion data with the user ID and the commercial entity ID and the second product ID or the second service ID upon determining that the probability exceeds a threshold; and
creating second sentiment group data within the social network account of the commercial entity based on the first opinion data that is mapped with the second product or second service.

11. The method of claim 1, wherein assigning the user ID to the first sentiment group data comprises creating instruction data to display a representation of the user with respect to a representation of the first sentiment.

12. The method of claim 1, further comprising:
receiving data regarding a second opinion of the user, the second opinion concerning the first product or first service;
assigning a first weight to the first opinion data;
assigning a second weight to the second opinion data, the second weight greater than the first weight, the second opinion data received after the reception of the first opinion data;
mapping the second opinion data with the user ID and the commercial entity ID and the first product ID or the first service ID;
creating data regarding a second sentiment group within the social network account of the commercial entity based on the mapped second opinion data, the second sentiment group providing an indication of a second sentiment of a social group regarding the first product or first service; and
removing the assignment of the user ID from the first sentiment group data; and
assigning the user ID to the second sentiment group data.

13. The method of claim 12, further comprising determining data regarding an offer for selling the first product or first service to the user based on the second sentiment group data.

14. The method of claim 1, further comprising determining data regarding an offer for selling the first product or first service to the user based on the first sentiment group data.

15. A method comprising:
receiving data regarding an opinion of one of a plurality of users, the opinion concerning a product or service offered by the commercial entity, the user designated as a social network friend of the commercial entity within a social network account of the commercial entity, the social network account maintained in a social network, the user having a user identity (ID) within the social network, the commercial entity having a commercial entity ID within the social network, the product having a product ID within the social network, the service having a service ID within the social network;
sending the opinion data via a network to a server;
receiving data regarding a sentiment group and data regarding a representation of the user from the server, the opinion data mapped with the user ID and the commercial entity ID and the product ID or the service ID, the sentiment group data created based on the mapped opinion data, the sentiment group data providing an indication of a sentiment of a social group regarding the product or service;
displaying the sentiment group within the social network account of the commercial entity based on the sentiment group data; and
displaying the representation of the user with respect to the sentiment group based on the data regarding the representation of the user.

16. The method of claim 15, further comprising:
receiving data regarding an offer for selling the product or service to the user, the offer data generated based on the sentiment group data; and
displaying the offer to the user.

17. A system comprising:
a network interface controller configured to receive data regarding a first opinion of one of the users, the first opinion concerning a first product or first service offered by the commercial entity, the user designated as a social network friend of the commercial entity within a social network account of the commercial entity, the social network account maintained in a first social network, the user having a user identity (ID) within the first social network, the commercial entity having a commercial entity ID within the first social network, the first product having a product ID within the first social network, the first service having a service ID within the first social network;
a processor configured to map the first opinion data with the user ID and the commercial entity ID and the first product ID or the first service ID,
wherein the processor is configured to create data regarding a first sentiment group within the social network account of the commercial entity based on the mapped first opinion data, the first sentiment group providing an indication of a first sentiment of the user regarding the first product or first service,
wherein the processor is configured to assign the user ID to the first sentiment group data; and
a memory device configured to store the first sentiment group data.

18. The system of claim 17, wherein the processor is configured to crawl one or more web pages to receive the first opinion data.

19. The system of claim 17, wherein the processor is configured to:
determine a probability that the mapped opinion data applies to a second product or second service, the second product assigned a second product ID and the second service assigned a second service ID, the second product offered by the commercial entity, the second service offered by the commercial entity;
map the first opinion data with the user ID and the commercial entity ID and the second product ID or the second service ID upon determining that the probability exceeds a threshold; and
create data regarding the first sentiment group within the social network account of the commercial entity based on the first opinion data that is mapped with the second product or second service.

20. The system of claim 17, wherein the processor is configured to create instruction data to display a representation of the user with respect to a representation of the first sentiment.
